(19) United States
(12) Patent Application Publication
(10) Pub. No.: US 2002/0104026 A1
(43) Pub. Date: Aug. 1, 2002

(54) Method and apparatus for providing a service to transfer messages over a communications network

(76) Inventors: Robert Barra, Crestwood, NY (US); Michael Vitale, New York, NY (US); James Christopher Lalos, Cypress, TX (US)

Correspondence Address: LACKENBACH SIEGEL, One Chase Road, Scarsdale, NY, 10583, US

(21) Appl. No.: 09/771,546

(22) Filed: Jan. 29, 2001

(51) Int. Cl. H04L 9/32

(52) U.S. Cl. 713/202

(57) ABSTRACT

A method and an apparatus are disclosed for providing specialized e-mail services to a sender, recipient or both, over a communications network. The method is composed of the following steps. On a computer operated by an e-mail sender, an online session with a computer at an e-mail center is established. The sender then sends an e-mail packet including an e-mail message destined to a recipient together with a request for a specified verification of e-mail service to the e-mail center. This e-mail is then transmitted from the e-mail center computer to an e-mail address accessible by a computer operated by a recipient, and when the recipient at least receives said e-mail, the e-mail center receives notification. And, in its turn, the e-mail center provides at least the requested e-mail notification to the sender. The apparatus provides the means for performing these steps. Options provided by this method and apparatus may include, among other things, obtaining one or more of the following: notification that e-mail was sent, notification that e-mail was received, notification that e-mail was opened, notification that e-mail was opened by intended recipient, notification of time and/or date of receipt and/or opening of e-mail, storage for future access of any selected notification information, storage of e-mail message contents for future access, verification of identity of sender, and verification of identity of recipient.

### BACKGROUND OF THE INVENTION

1. Field of the Invention.

This application generally relates to electronic mail (e-mail) communications, and, more specifically, to a method and apparatus for providing specialized e-mail services over a communications network, including providing to sender and/or recipient confirmation of delivery, opening of sent e-mails and/or verification of identity of a sender and/or recipient.

2. Description of the Prior Art.

It is becoming increasingly difficult and/or impractical to do business without resorting to or relying on e-mail. Research shows that widespread use is making e-mail critical to corporations. It is estimated that the total number of e-mail boxes increased from approximately 198 million at the end of 1997 to 325 million at the end of 1998. In 1998, there were 77 million e-mail users in the United States sending 246 million e-mail messages a day. By 2002, it is estimated that this will escalate to 131 million users creating 576 million messages a day on the Internet.

Electronic messages (e-mails) are therefore becoming increasingly important and, also, increasingly accepted for sending important messages that have commercial and/or legal ramifications.

Many corporations, as well as medium- to small-sized businesses are conducting more and more of their business on the web. These businesses and individuals are seeking to move their communication as well as business transactions to the web for a variety of reasons. Many see the web as a way of receiving data, contracts, etc., instantaneously rather than using the traditional overnight delivery companies. They also see the web as an alternative to expensive overnight package delivery and local courier services. It allows them to save money as well as increase the bottom line by not delaying the business decision-making process. Yet many companies are still hesitant about relying exclusively on e-mail because of the perception that “cyberspace” documents do not provide the same evidentiary safeguards that are available for postal or other delivery services. These companies are concerned about various issues, and are seeking a more secure and reliable alternative to traditional e-mail.

Just as with conventional notifications available with ordinary mail, it is frequently important to be able to verify or confirm that a message has been received by the intended recipient. Currently, e-mails are sent on both Intra- and Internet service providers (ISPs). While the sender is frequently provided with a message that the message “has been sent,” such message is typically very temporary in nature and the sender does not have a reliable method of verifying, at a later date, that the message was sent. Equally important, the sender does not typically have any way of verifying or confirming that the intended recipient indeed opened the electronic mail and, therefore, has read it.

While it may be possible to print a copy of the screen indicating that a message “has been sent,” this does not provide the reliability that the message was sent to a specific e-mail address or that, as noted, the intended recipient “opened” and, therefore, read the mail. A few Internet service providers (ISPs), such as AOL and Microsoft, do offer a limited service only to their own subscribers. This service allows the sender of an e-mail message using one ISP to receive a notification that the e-mail was opened by another subscriber using the same ISP. However, there is currently no way of determining whether the message was opened and read, or simply opened, by the intended recipient, and there is no way of determining whether the message was opened by the intended recipient or by someone else having access to the e-mail account. Even this limited service is not currently available when e-mail messages cross between different ISPs.

Pitney Bowes, for example, has a product “iSend.” ISend tracks and verifies document delivery to a sender via e-mail return receipt. The sender receives confirmation of the exact date and time the recipient retrieves the package. ISend seamlessly interfaces with all existing e-mail applications. ISend message recipients require no special software or proprietary protocols. Anyone with e-mail and web access can use it to send and receive deliveries.

UPS, through UPS Document Exchange, offers a product “UPS Online Courier.” UPS Document Exchange Online Courier also verifies receipt of electronic deliveries via e-mail. The sender has the option of requesting return receipt when shipping a document. An e-mail verifying receipt, if requested by the sender, is sent when the recipient accesses a document for a fee. Another feature of this product is its universal compatibility. Universal compatibility permits the sending and receiving of documents created in virtually any software.

E-mail outsourcing companies are also providing large corporations with secured e-mail services that provide such features as tracking and response. Critical Path, Inc., Mail.com, Inc., and Comm Touch Software, Ltd. are just a few of these e-mail outsourcing companies. Critical Path, Inc., provides business-to-business Internet message solutions for corporations, Internet service providers (ISPs), web hosting companies and web portals. In October 1999, Pitney Bowes began using Critical Path technology to bring the power of the ISend Online Document Delivery Service to the LAN e-mail desktop. Through this relationship, business users can access ISend directly from within existing desktop e-mail clients—including MS Exchange, Outlook, Lotus Notes, Novell GroupWise, MS Mail, Lotus cc:Mail, POP3 and IMAP4 systems—to send secure, trackable messages.

It seems that every company that has ventured into the e-mail messaging world have had two major concerns: Security and Receipt Verification. Security is dealt with in different ways, and with various encryption methodologies by each company. However, e-mail receipts using alternative methods do not appear to have been explored. All companies that have entered the e-mail messaging arena offer tracking and return e-mail as the method in which verification is provided to the sender that the intended recipient has received his or her e-mail.

United Parcel Service has entered the e-mail messaging world via UPS Document Exchange and only provides tracking and receipt via electronic means. And yet, when its parent company, United Parcel Service of America, delivers any packages via its traditional ground and express courier methods, consumers are offered a variety of ways to ensure that their packages are received. The consumer has a variety of ways to track his or her package. Consumers either track by telephone or via the web, and a hard copy of the signature is provided via fax, through USPS or by printing same off the web. If the sender chooses to print the receipt via the web, obviously no charge is assessed. Yet if the sender requests a fax or a hard proof of delivery, an additional charge is assessed for each successfully transmitted or mailed Point of Delivery (P.O.D.).

Even with these methods available, many traditional organizations, as well as individuals, use another option provided by UPS. At the time a shipper tenders a package to UPS, that shipper may request Delivery Confirmation Service by indicating Delivery Confirmation on the shipping record or by affixing a Delivery Confirmation label. Each Delivery Confirmation response includes the date of delivery and either the name of the recipient or the disposition of the package. All responses are consolidated and provided to the shipper every week, in printed or electronic format. What makes this additional service interesting is that it is widely used by UPS's customers, even though the same information is available through the worldwide web.

Another crucial element of secured e-mail is not just to ensure that the secured e-mail has been received, but also to eliminate the “postcard” configuration of traditional e-mail, i.e., the fact that anyone along the way can read a given e-mail's content. If one is sending an electronic document that is highly sensitive or personal, it is crucial that only the intended recipient read it. Recent surveys of Internet users by groups like the Information Technology Association of America/Ernst & Young, L.L.P., Lycos and NetZero have consistently identified security and privacy fears as a top impediment to e-commerce.

Many techniques have been used in the attempt to ensure that only the selected recipient is able to read a particular piece of electronic mail. Some companies and examples are listed below:

Tumbleweed Communications Corporation, through its Integrated Messaging Exchange Technology, offers a set of products and services that leverage the Internet and existing e-mail to enable secure, trackable and online communications. This corporation does so by posting the document on a server, safely inside the corporate network, and informing the recipient of the document's existence by e-mail. The recipient reads and retrieves the document using authentication and encryption technologies of protection. The server then confirms to the sender that the document was seen and received.

Pitney Bowes, through its product ISend, guarantees that the intended recipient is the only one to view the e-mail through its use of leading edge security. ISend uses several layers of security, including up to 128-bit encryption, password protection, secured socket layer and recipient authentication. Once the document/package is sent, the file is quickly uploaded to a secure Pitney Bowes ISend server located in a Level 5 secure data center. There it is stored in a secured, encrypted format (using 128 bit RSA^{™} technology) while awaiting pickup. Once the package is delivered, the server assigns a randomly generated Uniform Resource Locator (URL) to the package with their existing e-mail and web browser software.

British-based Software Company, through London's 1 on 1 mail.com, has developed a system with military-style encryption that is so high; it would be illegal to export if the company were based in the United States. 1 on 1 mail.com is different from other systems in that other systems leave the unencrypted versions of a message in the memory of the recipient's computer and with the Internet service providers that handled the message. Any one of these unencrypted versions can be recovered by a competent technician, often years after they have been “deleted.” Messages sent through the 1 on 1 mail system can be retracted without a trace.

UPS Document Exchange Online Courier is also highly secure and trackable. Similar to other products, Document Exchange is secure through 128-bit encryption and password protection. Anyone can enter an incorrect e-mail, but with password protection, even if such an e-mail goes to the wrong recipient, this recipient cannot open it. Companies like Kana, Mustang Software, Inc., and EGain Communications Corp. are trying to make businesses out of managing and disbursing this flow with software known as response systems. Kana develops software to monitor the e-mail flow and make sure responses are sent, if possible without involving a human. UPS Document Exchange has message memory. UPS's server stores the content of sent messages in encrypted form on its server, along with delivery details. Transactional information is saved for one year. The contents may be saved on the UPS Online Courier server for up to thirty days.

As previously discussed, it appears that all providers of secured e-mail provide confirmation of receipt via an electronic means. An electronic e-mail is sent to the sender once the intended recipient receives the e-mail. Even traditional transportation companies such as UPS that have ventured into the document exchange market do not offer their users an alternative way of receiving confirmation, even though, for their more traditional products of physical package shipping, delivery confirmation is provided electronically as well via the USPS (through the more traditional Proof of Delivery or through another product offering known as “Delivery Confirmation”).

As stated previously, only confirmation in electronic form is provided to senders of secure e-mails. An already noted example is iSend by Pitney Bowes, which functions as follows. First, the secure document is uploaded through secure connections by the sender to iSend server with an optional recipient password. Second, the server notifies the recipient via e-mail and provides individual URL to retrieve the document. Third, the recipient enters an optional password and retrieves documents through a secure connection. Fourth, iSend tracks and verifies document delivery to a sender via e-mail return receipt. No other option is provided to ensure that the recipient has received and read the e-mail.

Bolero.net is a company working on a global initiative to facilitate paperless international trade via the Internet. It offers many special features13 open technical standards, supporting networks that use IP (the Internet Protocol), as well as having messages that are sent via the bolero.net system adhere to SMTP mail protocol. Yet, when it comes time to inform senders if the recipient received that crucial trade transaction or international legal document, it does so via e-mail. Again, no hard copy or any other verification of receipt is provided.

As stated previously, the offering provided by United Parcel Service through UPS Document Exchange provides only an electronic receipt for a fee. The service does allow the capability to audit the package trail. The sender can track and verify time of receipt, opening and printing, and length of time the recipient spent reading the package. The sender must request a return receipt.

As companies have ventured into the Internet's secured e-mail arena, many obstacles were found that were in the way of any kind of ease of use. For example, it was not possible for the sender to receive information concerning the package (e-mail) if the recipient was using a different Internet provider, or if sender and receiver had different software applications on their computers. Along with fears about e-mail security, these obstacles impeded the progress and expansion of e-mail as an alternative to overnight delivery couriers or USPS mail. The companies previously discussed quickly learned how necessary it would be to change the method in which they were to use e-mail, if at all.

UPS entered the electronic document market in 1998 with two product offerings, UPS Online Courier and UPS Online Dossier. In the beginning, UPS Online Courier offered a more secure version than traditional e-mail. The sender needed either to install software on his or her computer or to access it from the Internet. All the recipient of the sender's e-mail needed was an e-mail address and Internet access. There was nothing provided in the way of high-level security or encryption. UPS Online Dossier was created for customers who needed the highest level of security. However, it required that both sender and receiver install software on their computers. In June 1999 the new UPS Document Exchange Online Courier 3.1. had its debut. The UPS Online Courier 3.1 version is compatible with standard desktop operating systems and offers full visibility real-time tracking, record retention, delivery confirmation and a password protection option. Further, no special software is required.

The company Occams-razor.com specializes in the electronic transfer of billing information. This eliminates the traditional barriers to electronic legal invoicing by differentiating and translating invoices sent in multiple formats. Using Occams product ShareDOC/LEGAL is easy as translating invoices sent in multiple formats, and as easy as e-mail. It requires nothing more than a browser and Internet access. The sender under this system is able to receive an electronic confirmation of receipt.

Pitney Bowes has joined forces with SAPAG to make web-based messaging easier, more reliable and more secure than ever before. Pitney Bowes′ iSend^{™} Online Document Delivery System is now available via SAP.com^{™} Marketplace; and, together, these services enable corporations to send and track the delivery of any file securely and reliably to anyone with an e-mail address on the Internet. It is the goal of companies entering this arena to have and provide an open collaborative business environment. ISend_recipients require no special software or proprietary protocols.

In some cases, as noted, electronic receipt information is available if companies/individuals are using different ISPs. The electronic receipt can sit at the application level such as with Tumbleweed or with UPS Document Exchange. None of the above-discussed companies, however, have ventured into providing senders with a proof of receipt that the document was received, or has been read, other than an electronic receipt. It is true that an audit trail is available that marks where the document is, whether it was sent to an incorrect e-mail address, etc., and in many instances this tracking information is saved for up to 90 days—but, again, only in electronic format.

Most companies that offer this secure electronic messaging service do provide a service for what they have labeled “oops” e-mail. In many instances, an e-mail transaction can be blocked right up to the second before it is received and/or opened by the intended recipient. In the overnight courier market, as well as in traditional ground delivery networks, carriers have provided information about a given package by means of a tracking number affixed to the package. The package is scanned and the data is available via the web and/or by calling the carrier. USPS and United Parcel Service offer additional alternatives for confirming or obtaining proof of delivery. Other carriers also provide additional ways of obtaining proof of delivery, but are more limited when compared to the U.S. Post Office or UPS.

The USPS has another service, “USPS Merchandise Return Receipt.” This is available for all USPS services. There is an additional charge for each merchandise receipt requested. In order to use this service, shippers must attach a completed return receipt form to the package. After the package has been delivered, the receipt—including consignee signature and date delivered—is mailed back to the sender.

United Parcel Service has another service for verifying that a package has been delivered—“Delivery Confirmation,” which was discussed above. Customers who select this additional service must do so at the time of shipping. Shippers who request Delivery Confirmation receive a printed response from UPS by mail, confirming the delivery. Responses are also available in electronic format (magnetic tape or EDI). These services are provided and used by customers even though the physical packages are tracked and delivery information is available and can be printed from the worldwide web.

It appears that customers who select this additional service are trying to obtain additional confirmation in the form of written proof in order to ensure delivery of high-value shipments, comply with government regulations and to facilitate payment collection. To what degree USPS Merchandise Return Receipt or UPS Delivery Confirmation is used at the present time has not been disclosed. Yet even though tracking has been available via the web for quite some time, neither carriers nor their competitor RPS have chosen to delete this option from their service offerings. Although in the traditional world of package and document delivery there are many ways of receiving tracking information as well as delivery receipt confirmation, in the secure e-mail world only electronic means are available. All the electronic services state that their systems are secured, yet not one provides a 100% guarantee that the secured e-mail was actually received by the intended recipient.

For example, all highly secured e-mail programs provide the highest security through encryption and a password. Yet the password, in one way or another, must be communicated with the recipient. UPS Online Courier allows the sender to use either the Online Courier account password or a unique password that the sender can create. But how does one prevent the password falling into the wrong hands?

In order to make senders more confident about exploring a more extensive use of secured e-mail, perhaps an additional or alternative delivery confirmation receipt should be explored.

The USPS offers consumers a variety of methods to receive confirmation or receipt of delivery for traditional packages and documents. However, there are exceptions depending on the type of package and its destination.

Certificate of Mailing is a receipt showing evidence of mailing. It can be purchased only at the time of mailing. The certificate does not provide insurance coverage for loss or damage, nor does it provide proof of delivery. No record is kept at the mailing office, and a receipt is not obtained when mail is delivered to the addressee.

Certified Mail provides proof of mailing and of delivery of mail. The sender receives a mailing receipt at the time of mailing, and a record of delivery is kept at the recipient's post office. A return receipt provides the sender with proof of delivery can also be purchased for an additional fee. Certified mail service is available only for first class mail or priority mail. Certified mail is not available for international mail. And Certified Mail does not offer insurance protection. For valuables and irreplaceable items, Express Mail or insured or registered mail must be used.

Registered Mail is the most secure option offered by the U.S. Postal Service. It provides added protection for valuable and important mail. Registered articles are placed under tight security from the point of mailing to the point of delivery. First class mail or priority mail postage is required on domestic registered mail. Return receipt and restricted delivery services are available for additional fees, and insurance can be purchased on domestic registered mail at the sender's option.

Return Receipt is the sender's proof of delivery. A return receipt can be purchased for mail sent cash-on-delivery (COD), Express Mail, mail insured for more than $50.00, registered mail or certified mail. The return receipt shows who signed for the item and the date that it was delivered. Unless prohibited by law, the return receipt also provides the delivery address if the address on the piece of mail is no longer correct. Return receipt service can be purchased in conjunction with restricted delivery service. It can also be requested before or after mailing, except for return receipt for merchandise service.

The importance of enhancing services in connection with e-mail and transmission of other electronic documents is highlighted by some recent developments. Thus, for example, the Electronic Signatures in Global and National Commerce Act (also known as E-Sign) recognizes that electronic signatures are becoming increasingly important and are increasingly being given the same weight as handwritten signatures for most commercial transactions. The Act was signed into law on Jun. 30, 2000. Also, E-Sign complements other electronic signature standards in other areas of electronic communications. Thus, for example, the U.S. government has proposed rules governing the use and disclosure of “individually identifiable health information” in the Health Insurance Portability and Accountability Act of 1996 (HIPAA). The E-Sign and HIPAA security rules address related concerns, namely, protecting the accuracy and security of messages transmitted by electronic means. Thus, for example, the HIPAA security rules require that the parties assure message integrity, non-repudiation (preventing the signor of a message from subsequently denying that he or she sent the message) and user-authentication (providing insurance of the claimed identity of an entity). All of these developments, plus others undoubtedly to come, must create an environment in which e-signatures may be more frequently used and relied upon, and be given legal effect to.

### SUMMARY OF THE INVENTION

Accordingly, it is an object of the present invention to provide a method of providing specialized e-mail services which eliminate the disadvantages inherent in prior art methods.

It is another option of the present invention to provide a method of providing specialized e-mail service that is simple to implement and use.

It is still another object of the present invention to provide a method of providing specialized e-mail services as in the previous objects that is reliable and provides safeguards to commercial and/or legal rights as between the parties communicating by e-mail.

It is yet another object of the invention to provide a method of providing specialized e-mail services which include the ability to provide notification to a sender that an e-mail has not only been sent but also opened and, therefore, presumably read by an intended recipient.

It is a further object of the invention to provide a method of providing specialized e-mail services to a sender, a recipient or both.

It is still a further object of the invention to provide a method of providing specialized e-mail service which allows the sender to request identification verification before the sending computer is authorized to send an e-mail, as well as identification verification of a recipient before the recipient is allowed to open an e-mail.

It is yet a further object of the invention to provide a method of providing specialized e-mail service that allows a recipient of an e-mail to request identification verification of a sender prior to opening received e-mail.

It is an additional object of the invention to provide a method of providing specialized e-mail service that provides safeguards to recipients of e-mails against viruses that can be harmful to recipients′ computer system.

It is still an additional object of the invention to provide specialized e-mail services which allow the sender of the e-mail to request that the notifications received by the sender that e-mail has been opened can be stored for a predetermined period of time for future possible use and reference.

It is yet an additional object of the invention to provide a method of providing specialized e-mail service that allows both the sender and the recipient to request that the contents of the e-mail message be stored for a predetermined period of time for future possible use and reference.

It is also an additional object to provide a notification and registration system and method of confirming delivery of an electronic message on Intra- and Internet providers that simulate a wide range of products, services and protections to both the sender and the recipient.

It is also another object of the present invention to provide a method providing specialized e-mail services which makes it possible to obtain notification and verification of the type aforementioned, which can be implemented between subscribers of the same Internet Service Providers (ISPs) or subscribers to different ISPs.

It is also another object of the present invention to provide a method of transferring messages between two or more people and vice versa by utilizing e-mail services, file transfer, instant messaging and any other means of electronically transferring messages between two or more people. This method allows a sender to utilize a website with specialized features to transfer messages.

It is also another object of the present invention to provide a method of transferring messages between two or more people by utilizing e-mail services, file transfer, instant messaging and any other means to electronically transfer messages between two or more people. This method will allow a sender to utilize an e-mail system, equipped with a service that has specialized features to transfer messages.

In order to achieve the above objects, as well as others which will become evident hereinafter, a method providing specialized e-mail services to a sender, recipient or both over a communications network include the steps of establishing an online session on a computer operated by an e-mail sender with a computer at an e-mail center, and sending, by the sender, an e-mail packet including an e-mail message destined to a recipient together with a request for a specified verification e-mail service to the e-mail center. The e-mail center computer transmits the e-mail to an e-mail address accessible by a computer operated by an intended recipient. The e-mail center receives notification when said recipient at least receives and opens said e-mail and, provides, by the e-mail center, at least the requested e-mail notification to said e-mail center.

Specialized services to be provided to sender, recipient or both include notification that e-mail was opened, notification that e-mail was opened by intended recipient, notification of time and/or date of opening of e-mail, storage for future access of any selected notification information, storage of e-mail message content for future access, as well as verification of identity of sender and/or recipient. Other notifications and/or verifications are possible and may be used in conjunction with the invention. For example, the sender may want to obtain notification as to the e-mail services requested by the recipient (e.g., storage of document text, verification of identity, etc.).

### BRIEF DESCRIPTION OF THE DRAWINGS

With the above and additional objects and advantages in view, as will hereinafter appear, this invention comprises the devices, combinations and arrangements of parts hereinafter described by way of example and illustrated in the accompanying drawings of preferred embodiments in which:

FIG. 1 is a schematic block diagram illustrating the system for providing specialized e-mail services to a sender, recipient or both in accordance with the present invention;

FIG. 2 is a flow chart illustrating one presently preferred sequence of method steps for implementing the method in accordance with the invention and illustrating three special services that may be requested, it being understood that other specialized e-mail services may also be included;

FIG. 3a is a flow chart illustrating the details of the method illustrated in FIG. 2 as it relates to the request of a return receipt by a sender without identification verification;

FIG. 3b is a flow chart illustrating the details of the method illustrated in FIG. 2 as it relates to the request of a return receipt by a sender with identification verification;

FIG. 4a is a flow chart illustrating the details of the method illustrated in FIG. 2 as it relates to the request of certification by a sender without identification verification;

FIG. 4b is a flow chart illustrating the details of the method illustrated in FIG. 2 as it relates to the request of a certification receipt by a sender with identification verification;

FIG. 5a is a flow chart illustrating the details of the method illustrated in FIG. 2 as it relates to the request of a registration by a sender without identification verification;

FIG. 5b is a flow chart illustrating the details of the method illustrated in FIG. 2 as it relates to the request of a registration with identification verification;

FIG. 6 is a flow chart illustrating the details of a Pure Web solution;

FIG. 7 is a flow chart illustrating the details of the Pure Web solution utilizing an authentication database;

FIG. 8 is a flow chart illustrating the details of retrieving email while utilizing a Pure Web solution;

FIG. 9 is a flow chart illustrating the details of retrieving email while utilizing a Pure Web solution that includes an authentication database;

FIG. 10 is a flow chart illustrating the details of a specially enhanced email service method;

FIG. 11 is a flow chart illustrating the details of the specially enhanced email service method utilizing an authentication database;

FIG. 12 is a is a flow chart illustrating the details of the specially enhanced e-mail service method utilizing a POP/IMAP account;

FIG. 13 is a flow chart illustrating the details of a Mail center;

FIG. 14 is a flow chart illustrating the continuation of the details of the Mail center of FIG. 13;

FIG. 15 is a flow chart illustrating the authentication process for the Mail center;

FIG. 16 is a flow chart illustration the Mail Center handling the request for e-mail; and

FIG. 17 is a flow chart illustration of an authentication algorithm utilized for the specially enhanced e-mail service.

### DESCRIPTION OF THE PREFERRED EMBODIMENTS

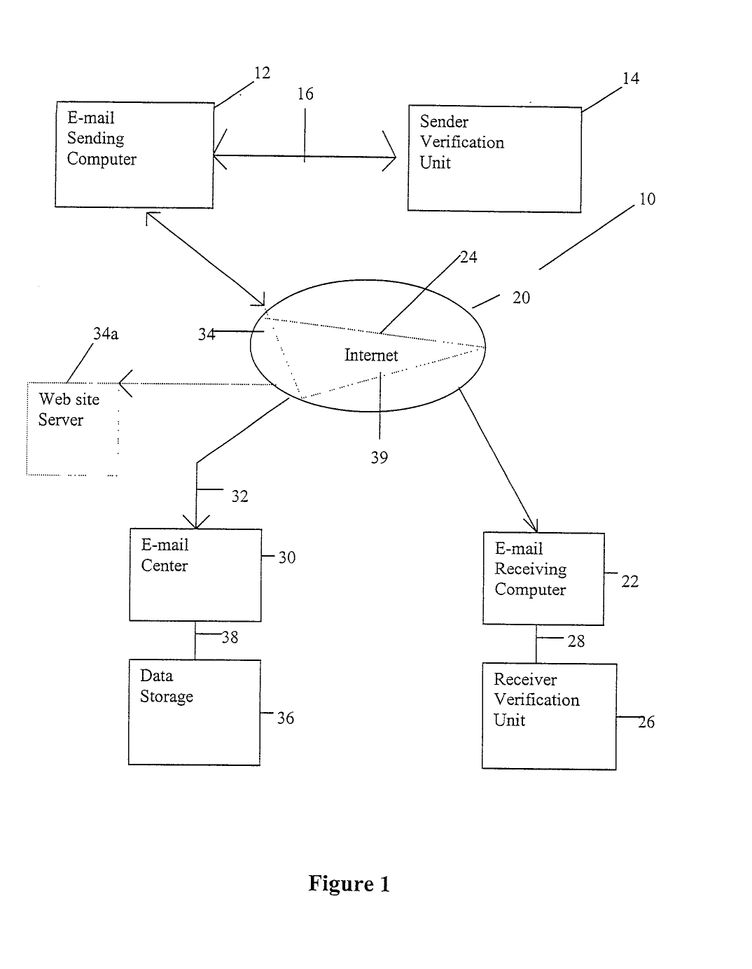

Referring now specifically to the Figures, in which similar or identical parts are designated by the same reference numerals throughout, and first referring to FIG. 1, a system for providing specialized e-mail service in accordance with the invention is generally designated by the reference numeral 10.

The system 10 and method of providing specialized e-mail services in accordance with the invention can be used to provide such services to a sender, recipient or both over a communications network. In FIG. 1, an e-mail sending computer used by the sender of an e-mail message is designated by the reference numeral 12. In accordance with a preferred embodiment of the invention, the computer 12 has associated therewith a sender identification verification unit 14 linked to the computer 12 by means of a suitable link or line connection 16. The sender verification unit 14 may also be built in or incorporated into the computer 12 itself. In addition, the verification unit 14 can also be a part of an Internet web site 34 that computer 12 utilizes to send e-mail such as YAHOO MAIL. The specific manner in which the verification unit 14 cooperates with the computer 12 is not critical, and any identification verification unit may be used. From the field of biometrics it is known that it is possible to verify the identity of a user in numerous ways, including checking the user's fingerprints, retinal identifying information, voice patterns, etc. These and other biometric approaches may be used in connection with this invention for both the sender as well as the recipient, as will be described hereafter.

The computer 12 is connected in any conventional way by means of a link 18 to a communications network. In the presently preferred embodiment, such communications networks are shown as the Internet 20. However, it will also be evident that this invention can be used also in connection with other communications networks, include private, quasi-public and public networks. These include local, Intranet and dial-up networks.

In a typical situation, the user of the sending computer 12 needs to electronically transmit an e-mail message, document or attachment to an e-mail to a specific recipient, represented by receiving computer 22. In the conventional manner, the sender uses any traditional or available e-mail software and composes a message and/or attaches to his or her message any suitable document. The sender then transmits the contents of the e-mail message, together with any attachments, to the recipient's e-mail address. Such conventional method of sending an e-mail directly to a recipient is represented by the dash line 24. In addition, a person utilizing computer 12 is capable of going to an Internet website 34 to send and receive e-mail. Of course, the connection shown is not precise, and the representation is merely illustrative to facilitate the discussion. Depending on the Internet Service Provider (ISP) used by the sender, and depending on the ISP used by the recipient, the e-mail message may be routed to various servers until the message is lodged on the server of the recipient's Internet provider. The intended recipient, in turn, can access his or her ISP's server and retrieve his or her message. As suggested in the “Background of the Invention,” once the sender's e-mail is forwarded and finds its way the recipient's e-mail server, the sender is provided with a message that the message has been “sent.” The recipient is typically provided with a message that there is “new mail.” The recipient can, if he or she desires, open such new mail. Otherwise, such new mail can be ignored or deleted. The sender does not typically know what the fate of his or her message is, and whether such message is, in fact, ever read by the recipient. With some ISPs, subscribers of the same ISP can, in some instances, be notified that their messages have actually been opened. Such service is provided by AOL and MSN. However, currently, such limited service is not provided across different ISPs.

An important feature of the present invention is that the sender or user of the sending computer 12 has certain options, as does the intended recipient. Thus, the sender can request specialized e-mail services, and the recipient can likewise be provided with certain options prior to or subsequent to opening the mail received from the sender. However, in order to provide some of these additional e-mail services, it may be necessary or desirable to provide a receiver verification unit 26 associated with the computer 22 in any suitable or conventional way. The verification unit 26 may, as with the verification unit 14, also be built in or incorporated into the receiving computer 22 itself. Again, the specific manner in which the verification unit 26 cooperates with the computer 22 is not critical, and any identification verification unit may be used to identify the identity of the recipient. Any biometric device suitable for the purpose may be used and may be the same as or different from the biometric device used to verify the identity of the sender 14.

In order to achieve the objectives, advantages and/or benefits of the present method, an important feature of the invention is the provision of an e-mail center 30 that is in the form of a server linked by any suitable means, at 32, to the Internet 20. An important feature of the invention is that a message sent by sending computer 12 to the receiving computer 22 is no longer a “direct” transmission represented by dash line 24, but such message is first transmitted to the e-mail center 30 by means of a path 34 or dash line 34. Path 34 utilizes a software program on website server 34a to interpret information that may be sent by computer 12. Website server 34a may be a separate server or device or it may be a part of e-mail center 30. There are three different methods for providing e-mail services, file transfer, instant messaging etc.

The first method for transmitting an e-mail message is represented by the dash line 34 is achieved by having the sending computer 12 establish an online session with the computer and e-mail center 30. Now, instead of the sender sending only a message to an intended recipient, the sender sends an e-mail packet via path 34, which includes both the e-mail message destined to the recipient, together with any attachment and a request for specified special e-mail service(s) to e-mail center 30. E-mail center 30, in turn, transmits the sender's e-mail message to an e-mail address accessible by a computer operated by the recipient, by way of path 39. Normally a simple re-transmission of the message by the e-mail center 30 to the intended recipient would have all of the characteristics of the original e-mail had it been sent directly by sending computer 12 to receiving computer 22 by way of direct path 24. However, in order to provide the greatest spectrum of e-mail services, the workstation representing the receiving computer 22 and/or the ISP of the recipient is advantageously provided with software that can ascertain if and when the intended recipient actually opens the e-mail message. Such software, at the receiving end, makes it possible for the e-mail center to receive notification as to when the recipient at least receives the e-mail and, as noted, as to when the recipient opens such e-mail. Such notification to the e-mail center 30 may also be represented by the dash line 39 as a path of data transmission between the receiving computer 22 and the e-mail center 30. Once such notification is received by the e-mail center, an important feature of the invention is the re-transmission of at least part of or all of the information received by the e-mail center back to the sender, as may have been requested or contracted by the sender. Thus, the more services that the sender requests and contracts to receive, the more such information may be transmitted to the sender under any given circumstances.

Preferably, the sender establishes a secure session with e-mail center 30. While it is preferable that the communications between the sender, recipient and e-mail center 30 be as secure as possible, the primary feature or essence of the present invention is not strictly security to prevent authorized people from having access to messages but the ability to establish evidence that certain information was transmitted to a person who has received and read such information. At one level, therefore, the essence of the present invention is to provide special mailing services somewhat analogous to the specialized services provided by the U.S. Postal Service in the form of return receipt requested, certified mail and registered mail.

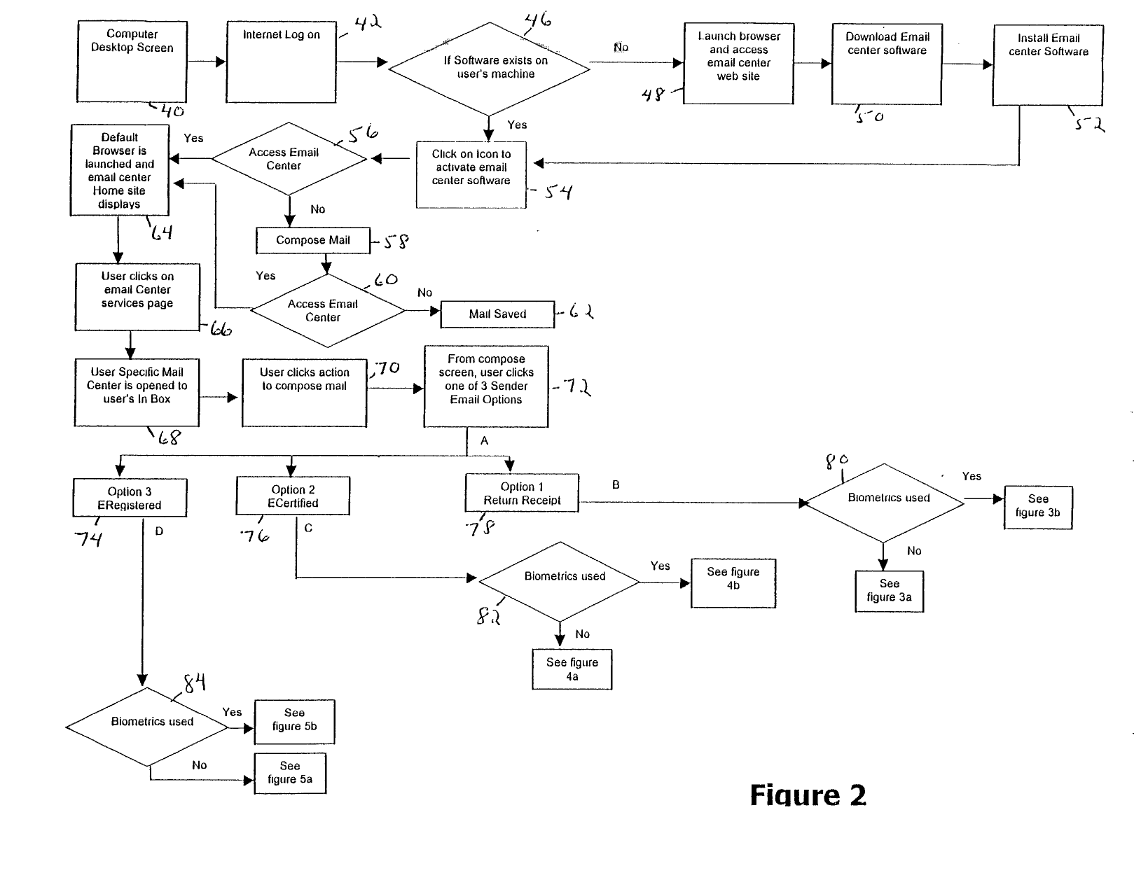

The broadest aspects of the method in accordance with the present invention, and associated system hardware, will be generally described in connection with FIG. 2. The computer desktop 40 generally corresponds to sending computer 12 shown in FIG. 1. Initially, the sender is required to log onto the e-mail center 30. However, as indicated, such log-on may take place through the Internet, direct dial, etc. In the discussion that follows, the communications network will be assumed to be the Internet, those skilled in the art being fully aware of the changes or modifications that would need to be made to access the e-mail center 30 by means of another, alternative communications networks. Thus, at block 42, the user/sender logs onto the Internet in a conventional manner, such as by dial-up, direct 56 k-line, DSL (Digital Subscriber Line), T1, etc. Preferably, any attempt to log onto the mail server will prompt the user, at least initially, to indicate whether the desktop is provided with the e-mail center software on the user's machine at block 46. If such software does not exist, the computer is set up to launch a browser and access the e-mail center web site. Responding in the negative launches the user's browser, at block 48, to access the e-mail center web site, the software of the e-mail center being downloaded to the user/sender at block 50. Once such software is downloaded, the user can install such software on the station or desktop, at 52. This can place a short cut icon on the user/sender's desktop for activating the e-mail center software.

In order to initiate a transmission of an e-mail to an intended recipient, with request for additional e-mail services, the sender can click on the icon on the desktop, at 54, to activate the e-mail center software. Such software queries the sender as to whether to access the e-mail center. If the sender selects “NO,” the sender can work off-line and, for example, compose mail off-line, at block 58. After such mail has been composed, the e-mail center software can again query as to whether the sender wishes to access the e-mail center to send such composed mail. At block 60, the sender is again prompted as to whether the e-mail center is to be accessed so that the mail composed at block 58 can be sent. If the answer is “NO,” the sender may be prompted as to whether such mail is to be saved, at block 62. In the event the user wishes to access the e-mail center, either at blocks 56 or at 60, the user can activate the default browser at block 64 to access the home site of the e-mail center, which would provide the sender with a series of options. Once at the e-mail center home page, the sender can, at block 66, activate a desired web services page for sending a message to the intended recipient. In the event that the user has not composed mail “off-line,” the sender may, after opening sender's “Inbox” at block 68, compose mail online, at block 70.

It will be appreciated that the sequence of steps aforementioned is not critical, and certain of the steps may be transposed or interchanged. Thus, for example, the user may be prompted by the e-mail center software at block 42 whether the user wishes to compose mail off-line. Clearly, the specific point at which the mail is composed is not important, as long as the user has an opportunity to compose the mail either off-line or online at some point prior to completing the session with the e-mail center. Sending computer 12 may not contain special e-mail software that enables the sender to utilize Postal Hut e-mail services so a specially enhanced email service may be added to sending computer's 12 e-mail program. In block 46, sending computer's 12 e-mail system checks if sending computer 12 has Postal Hut specialized e-mail services or a specially enhanced e-mail service. If sending computer 12 has a specially enhanced e-mail service, as described in the following method, then, the sending computer can send the e-mail to e-mail center 30.

Once the mail has been composed and is ready to be sent to the intended recipient, e-mail center 30 provides the sender with a series of options for special e-mail services. Such services fall into three primary categories. One group of services involves notification, the second is storage of information and the third is identity verification. Notifications may include, but are not limited to, notification that an e-mail was sent, notification that an e-mail was received, notification that an e-mail was opened, notification that an e-mail was opened by the intended recipient, notification of time and/or date of receipt and/or opening of e-mail. Another e-mail service includes storage of any of the aforementioned notifications for future access and/or use. A further storage function is the storage of the actual e-mail message contents for future access and/or use. Finally, the e-mail center can provide verification of the identity of the sender and verification of the identity of the recipient to prevent unauthorized opening of an e-mail message that may be delicate in content, confidential and/or privileged.

At block 72, the sender can make the selections of special e-mail services, this being exemplified at blocks 74, 76 and 78, at which the sender can request “return receipt” at 74, that the e-mail message be “e-certified” at block 76 and/or that the e-mail message be “e-registered” at 78. These illustrative services can be briefly explained as follows. When the sender requests a “return receipt,” at block 74, e-mail center 30 is being requested to provide the sender with a notification that the e-mail was sent, received and/or was opened by a recipient operating the e-mail receiving computer 22. This is to be distinguished from verification of identity of recipient, as will be discussed hereinafter. The second option, at block 76, is “e-certification” of mail, which involves the storage of the requested notification in the e-mail center data storage system 36. The third option, at block 78, is similar to the previous options, with the exception that in addition to storing the notification and/or verification information regarding the identity of the recipient, e-mail center 30 additionally stores the contents of the e-mail in the data storage system 36 for future access and/or use.

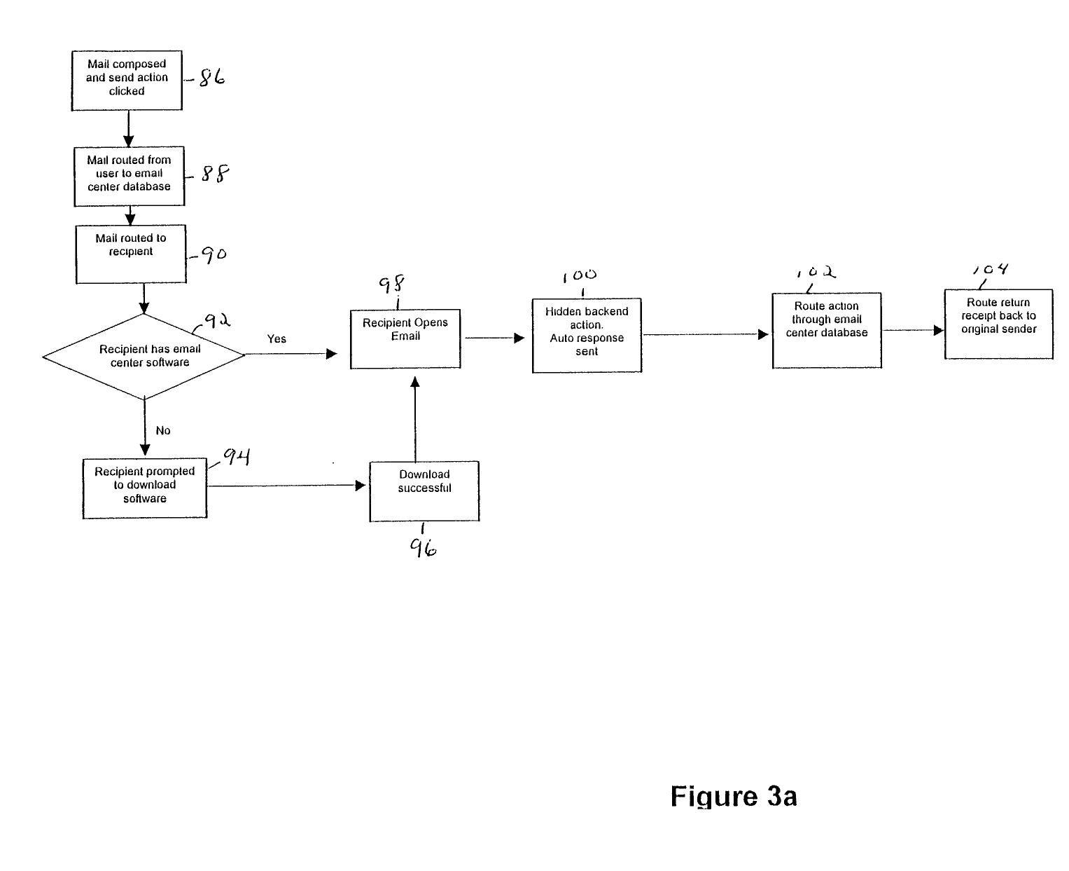

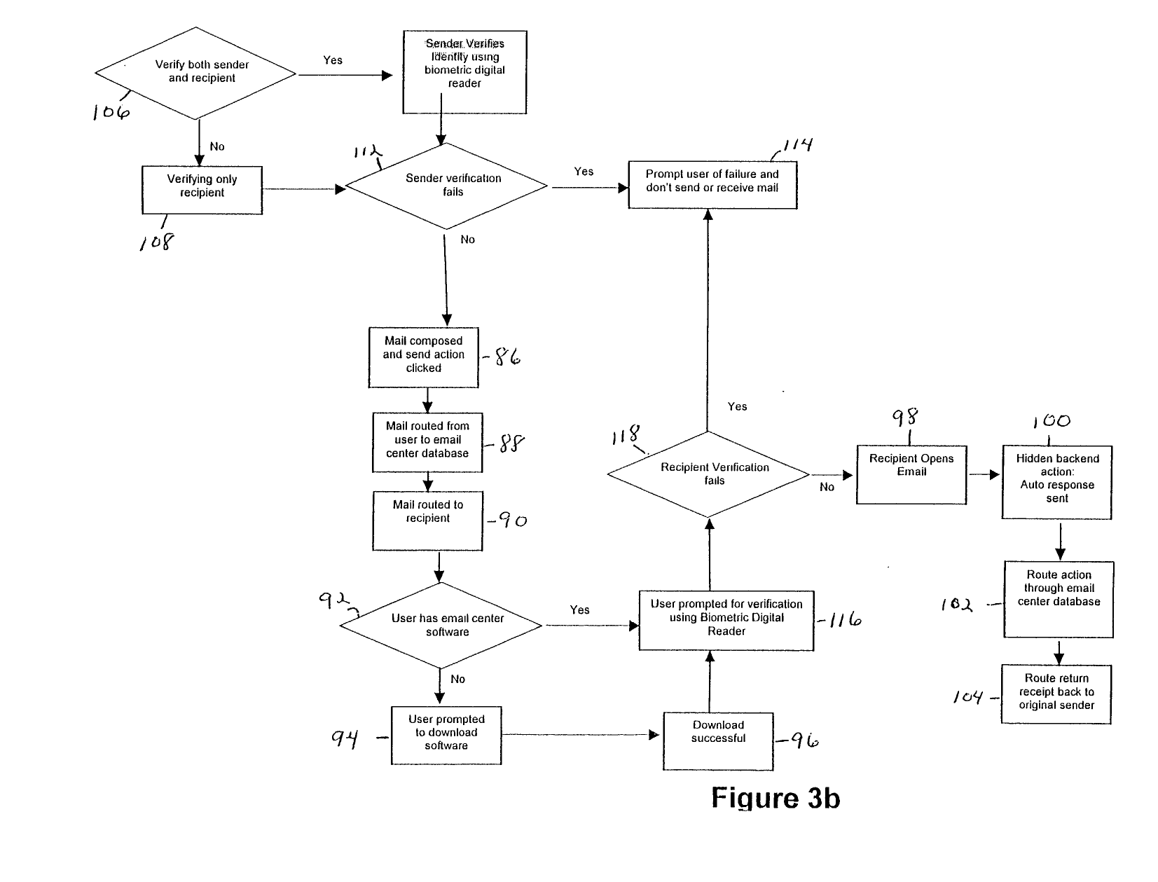

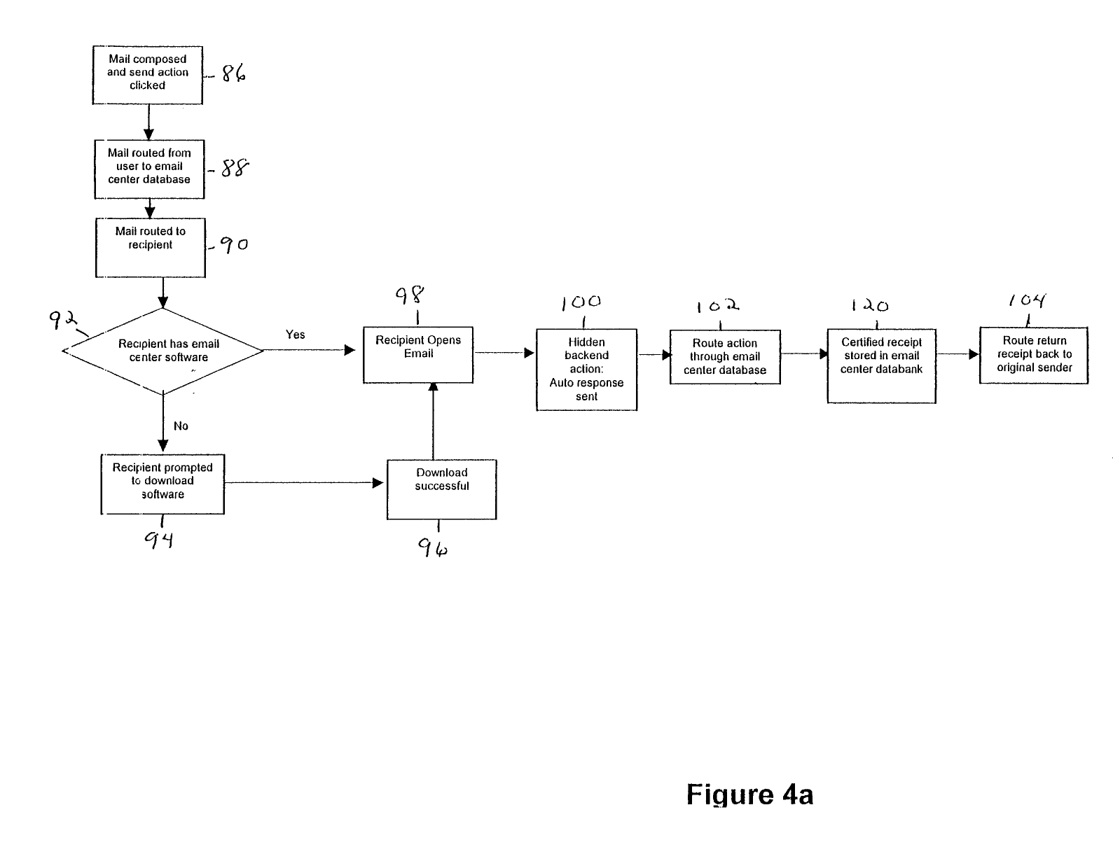

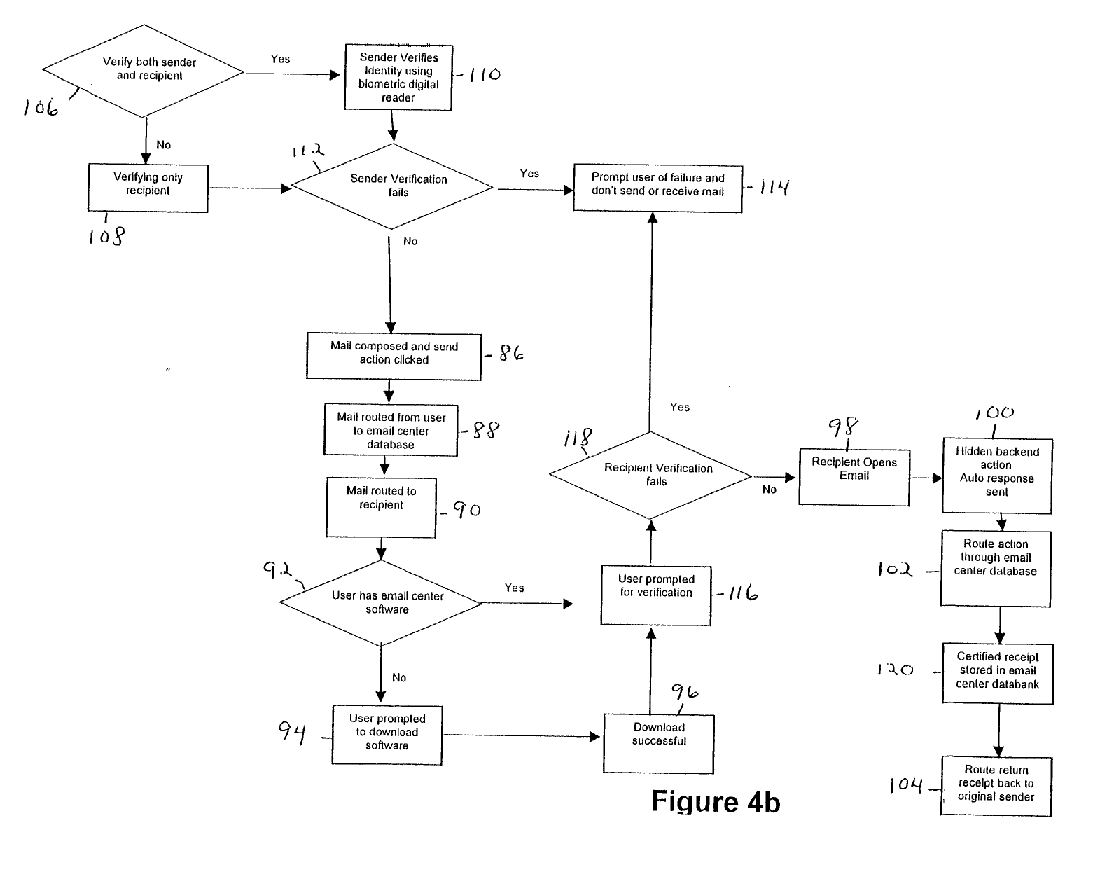

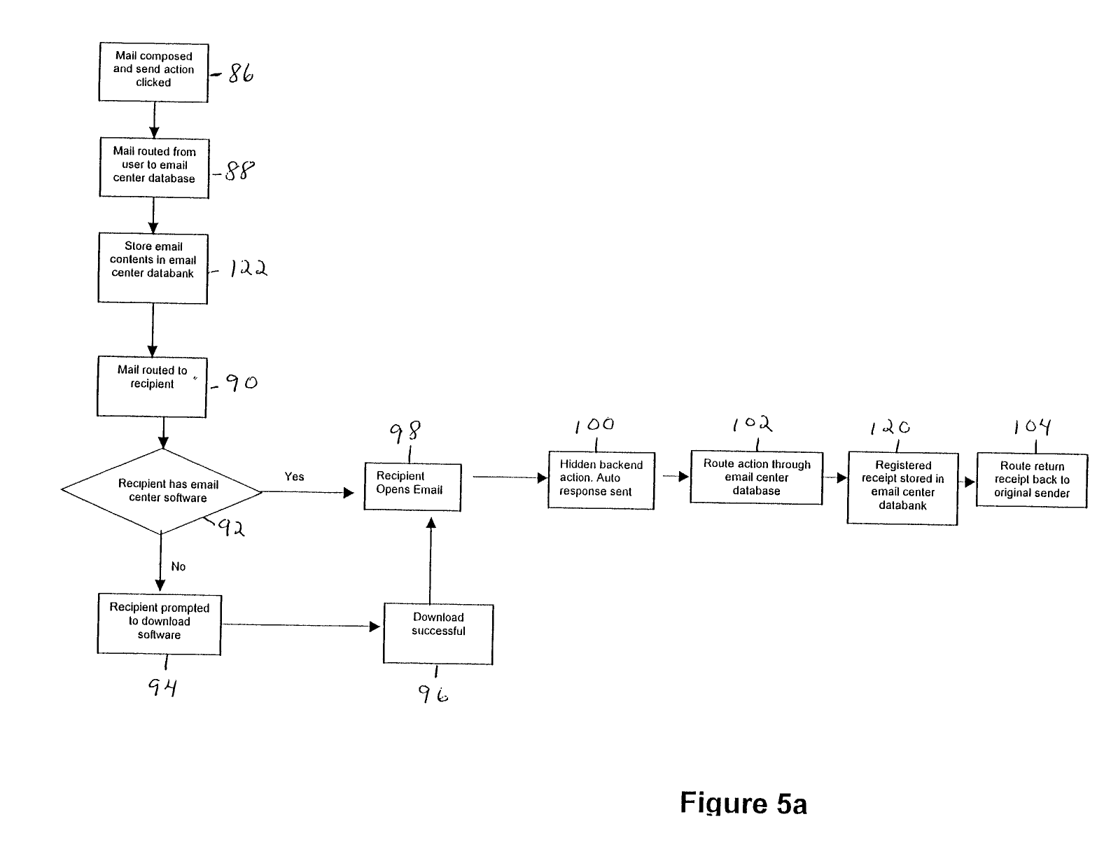

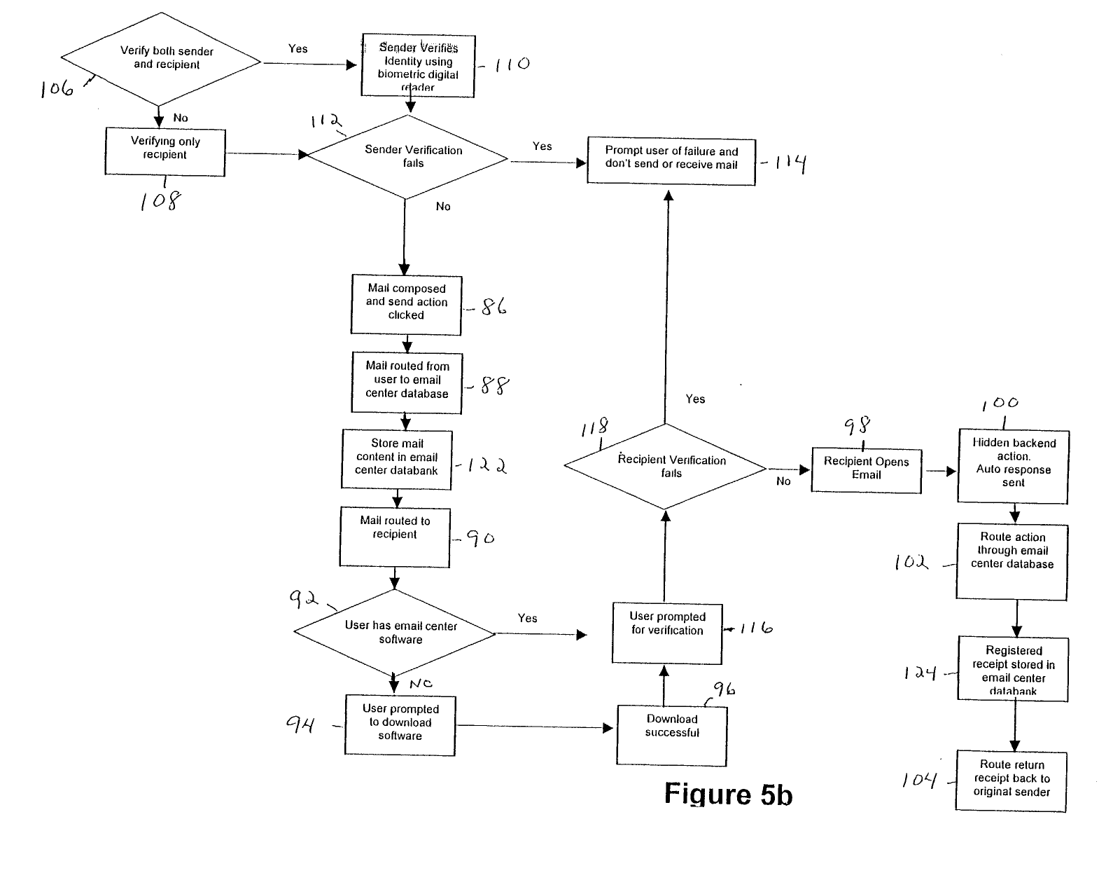

As will be noted from FIGS. 2-5b, the procedures or sequences of steps for all three options are substantially similar or the same, with the exception of what is stored or not stored for future use. These differences aside, the method steps, procedures or functions are generally the same for all three options and, therefore, only FIGS. 3a and 3b will be discussed in detail, such discussion also being applicable to FIGS. 4a, 4b, as well as FIGS. 5a, 5b, with the only exceptions having been noted, and to be indicated again below.

To initiate a “return receipt” by the sender without the request for verification of identity of recipient, reference is made to FIG. 3a, in which the sender chooses to send the composed e-mail at block 86, and such mail is routed to the e-mail center 30 by way of path 34, as aforementioned. At block 90, the e-mail center routes the mail to the intended recipient, by way of path 39. The e-mail center then tries to establish whether the intended recipient has the e-mail center software on the recipient's workstation or receiving computer 22. This check can be conducted either prior to or subsequent to the routing of the mail to the recipient at block 90. Such determination can be made from information stored in the data storage system 36 of the e-mail center 30. Thus, if the e-mail center had shipped such software to the intended recipient and/or the intended recipient had previously registered or used the service, such information would be available to the e-mail center. If the e-mail center 30 determines that the intended recipient does not have the required software, the recipient or user may be prompted to download the software, at block 94, such as by sending a separate e-mail message by the e-mail center 30 to the intended recipient. Block 96 represents a successful download by the intended recipient of the software.

If the recipient has the requisite e-mail center software, or has successfully downloaded such software, at block 96, the intended recipient can then open the e-mail message, at block 98. As soon as such e-mail is opened by the intended recipient, a hidden back-end action or autoresponse is initiated by the e-mail center software on the recipient's work station, at block 100, which is in the nature of a hidden action, or transparent to the recipient. However, once such auto-response has been generated, the “action” taken transmitted to the e-mail center at block 102. Receipt of such information by the e-mail center of such information enables the e-mail center to route a “return receipt” back to the original sender, via path 34, to confirm and notify the sender of the outcome of the special services that have been requested. Once the return receipt has been forwarded to the sender's e-mail address, the sender can print out such return receipt for future reference and use. Such would normally terminate that transaction.

In FIG. 3b, which is generally similar to FIG. 3a, with the exception that a sequence is illustrated that may be used to provide verification of identity of the recipient should such special service have been requested by the sender. Thus, at block 106, the sender is prompted as to whether the sender wishes to verify the identities of both the sender and the recipient. In some instances, the sender may set up a default to also require verification of the sender to ensure that e-mails cannot be transmitted from his or her “Inbox” by an authorized party. If the sender wishes to verify both the sender and the recipient, the sender can verify his or her own identity at block 110 by using the sender verification unit 14. As indicated, such verification unit may take any suitable form, and may use a biometric device associated with a computer. The verification units can, for example, read the individual's fingerprints, voice, anatomical features, retinal information, or the like. If such verification fails, at block 112, the sender is prompted of such failure of verification, at block 114, and the e-mail center software may be set up to default in those circumstances and block the sending computer 12 from sending any messages from either such computer or any other computer using the sender's “Inbox.” However, if the sender does not require that his or her identity be verified, the e-mail center software can be requested to only verify the identity of the recipient, at block 108. The recipient verification step, at block 108, is implemented at the recipient's workstation 22.

If sender verification is successful, the sender can choose to send composed mail, at block 86, and route the mail from the sending computer 12 to the e-mail center 30, at block 88. Such mail can then be routed to the recipient, at block 90. As indicated previously, the e-mail center 30 can try to establish whether the intended recipient already has the e-mail center software on the desktop or receiving computer 22, at block 92. Such determination can be made either by sending a separate e-mail to the intended recipient, prior registration by the recipient, prior mailing of the software to the recipient or the like. Again, if it is established, at block 92, that the intended user or recipient does not have the e-mail center software, at block 92, the user or recipient may be prompted to download such software at block 94. Any one of a number of conventional methods of prompting the recipient can be used. Once such software has been successfully downloaded, at block 96, the user is prompted for verification using a biometric digital reader, at block 116. This is a phase of the activity that differs from the services requested and exemplified in FIG. 3a. If the sender has requested verification of identity of the recipient, such verification may be performed by using the receiver verification unit 26. Of course, if the intended recipient does not have the benefit of or access to a receiver verification unit, such verification cannot be performed. Instead, the user can be prompted to obtain such receiver verification unit either by the e-mail center or from another suitable source.

If the verification fails, at block 118, the sender is again prompted of such failure, and the intended recipient is not provided with the mail in a form that can be opened. However, if verification is successful, the e-mail message is provided to the intended recipient, who can then open such mail. As previously noted, as soon as such mail is opened, a hidden back-end action in the form of an auto-response is sent back to the e-mail center 30, at block 100. Such auto-response initiates the generation of an “action” confirmation through the e-mail center, at block 102, and a return receipt is sent back to the original sender, at block 104. Again, the sender can print out or store such return receipt for future access and use.

Referring to FIGS. 4a and 4b, these are identical to FIGS. 3a and 3b, respectively, as aforementioned. However, in both FIGS. 4a and 4b, an additional “certification” step or function is provided in the sequence, designated by the reference numeral 120, at which the “certified” return receipt is stored in the data storage system 36. Except for such storage for future reference and use, all of the other steps may be the same, with or without verification of identity. Similarly, in FIGS. 5a and 5b, which are also generally similar to FIGS. 3a and 3b, respectively, these represent additional protections for the sender. Not only can the sender store the “certified” return receipt, at block 120, but also the e-mail contents in the data storage system 36 of the e-mail center, at block 122. Clearly, this provides additional safeguards in the event of a possible dispute between the sender and the recipient, as to what was sent by the sender, whether such information was read by the recipient, as well as the specific contents of the message that was read. There can be little or no dispute, accordingly, at least as to these issues, which are all documented in the data storage bank 36. This added feature is referred to as “registration” and a registered receipt is stored and routed to the sender, at blocks 120 and 104 in FIGS. 5a and 5b.

An important feature of the invention is also the ability of both the sender and the recipient to request and obtain specialized e-mail services. This is unlike the analogous services provided by the U.S. Postal Service or other mail services, all of which are typically requested by and provided to the sender of a letter or package. Because of the structure and flexibility of computers and e-mail messaging in general, both the sender and the recipient can request, from their desktop, that they be provided with any of the aforementioned notifications for their own records, as well as a copy of the contents of the message sent and stored in the data bank.

Additionally, a feature of the present invention is that the intended recipient can, as a condition of opening a specified e-mail, first request verification identification of the sender. This may be helpful to a recipient in positively identifying that a certain communication was, in fact, transmitted by a specified individual. Furthermore, an e-mail recipient may also want to obtain position verification that an e-mail has, in actuality, been sent by a specified individual whose identity has been verified prior to opening an e-mail or attachment thereto. This may become increasingly important with the advanced viruses that proliferate in connection with e-mails and become more sophisticated and more difficult to monitor and detect. This is particularly true with many of the more contemporary viruses, which are programmed to indicate that a specified message has been sent to an individual from someone known to the recipient and with whom prior e-mail messages and possibly business has been exchanged. Viruses can, in many instances, masquerade themselves and cleverly select subject lines and specify other familiar information readily available from the recipient's or sender's computers to make it appear that it is a message or attachment that is safe to open. However, if such message or attachment was automatically sent by a virus, without the knowledge of the apparent sender, the recipient may very well want to positively verify that the sender intentionally forwarded or transmitted the message before the recipient opens the message. Therefore, unlike heretofore known postal and other services provided to senders of information and products, the sender and recipient are now placed on a more even footing, as they should rightfully be, if such specialized e-mail services can become important from a legal or financial standpoint. Both parties to the transaction should, therefore, have the right and the opportunity to equally protect themselves and, thereby, hopefully try to avoid difficulty or conflicts in the future that might, in some instances, arise without such specialized e-mail services and their inherent positive evidentiary value and certainly.

An apparatus or system for achieving the objects of the present invention includes the elements, components or features illustrated in FIG. 1 for performing the functions or operations heretofore described.

Once set up, e-mail center 30 is also an ideal vehicle for providing enhancements to e-mail services. For example, a sender can select greeting cards, wedding invitations and invitations for other celebrated occasions, mailers, business letters with concomitant letterhead and logo, and any other stationery or postal functions. A variety of web sites are available that provide some of the services mentioned.

E-mail center 30 can, thus, provide visitors to the site with the ability to send free electronic greeting cards. Aside from free electronic greeting cards, this site can provide other services, for a fee. A visitor to this site can order physical (hard-copy) greeting cards for all occasions, wedding invitations, as well as balloons, baskets, stuffed animals, etc. E-mail center 30 can also snail-mail physical (hard-copy) cards for the visitor. All the visitor needs to do is personalize the card. E-mail center 30 can also offer other services such as stationery, supplies and business cards. It can offer an entire range of such services, or specialize in niche services. E-mail center 30 can also provide consumers with service contracts and preventive maintenance contracts. Customers that visit the site can order a variety of supplies such as New/OEM Cartridges and Facsimile Cartridges and supplies.

E-mail center 30 may also be set up to provide e-mail based scheduling services. It can allow users to set up meetings and convey additional information, such as a meeting's address or participants. E-mail center 30 can do so across the Internet, and not just within a corporate network, where Microsoft Outlook provides a similar function. Participants can reply by e-mail, and e-mail center 30 can consolidate responses to determine when mutual availability exists.

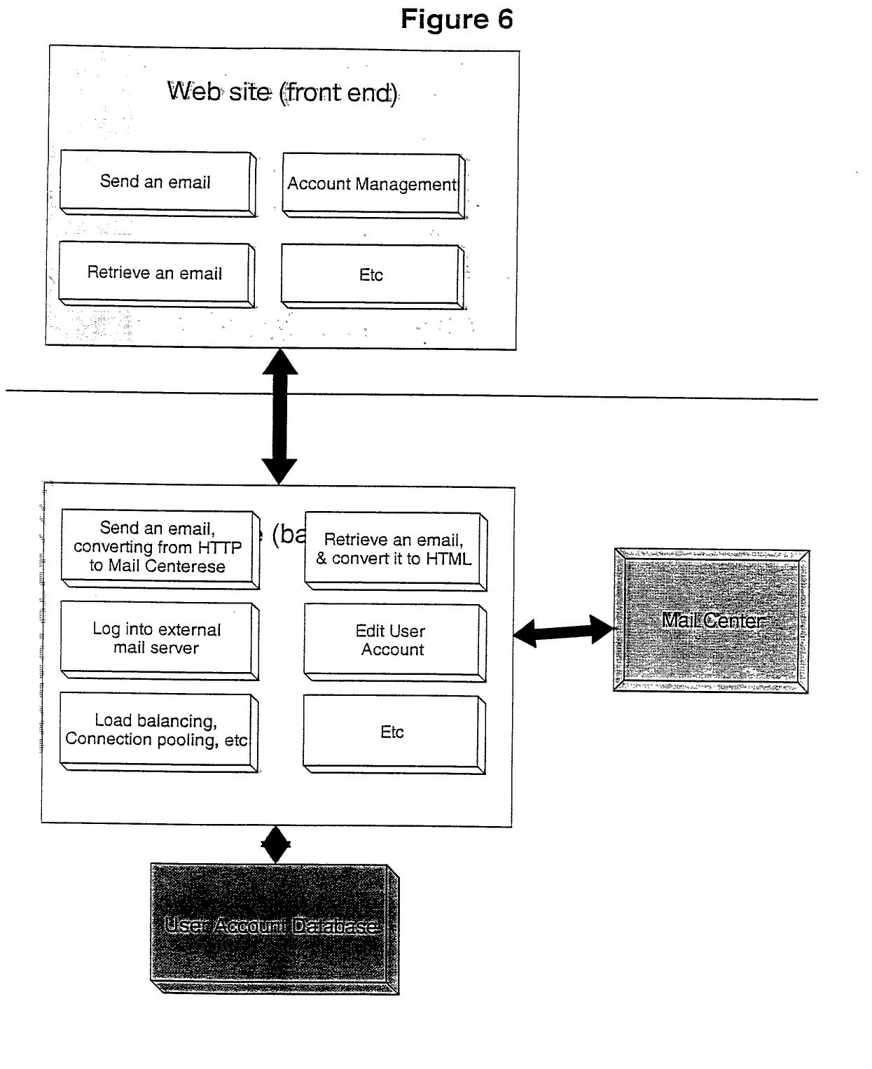

A second method for transferring electronic message is a Pure Web solution that utilizes Path 34 as an Internet Website such as the Postal Hut Website or any other website that is able to receive and send e-mail. Referring to FIG. 6, the Pure Web solution is depicted whereby sending computer 12 utilizes a website to send e-mail to receiving computer 22. Referring to FIG. 1, when Path 34 is an Internet Website, such as the Postal Hut Website, computer 12 submits the relevant information, e.g. recipient, subject, content, Postal Hut functions, etc., to a software program on Website server 34a. Postal Hut functions include: return-receipt, eCertified, eRegistered, authentication, etc. The software program on website server 34a interprets computer 12's request and delivers it to e-mail center 30. Those of ordinary skill in the art will recognize that website server 34a can be a separate device or it can also be part of e-mail center 30.

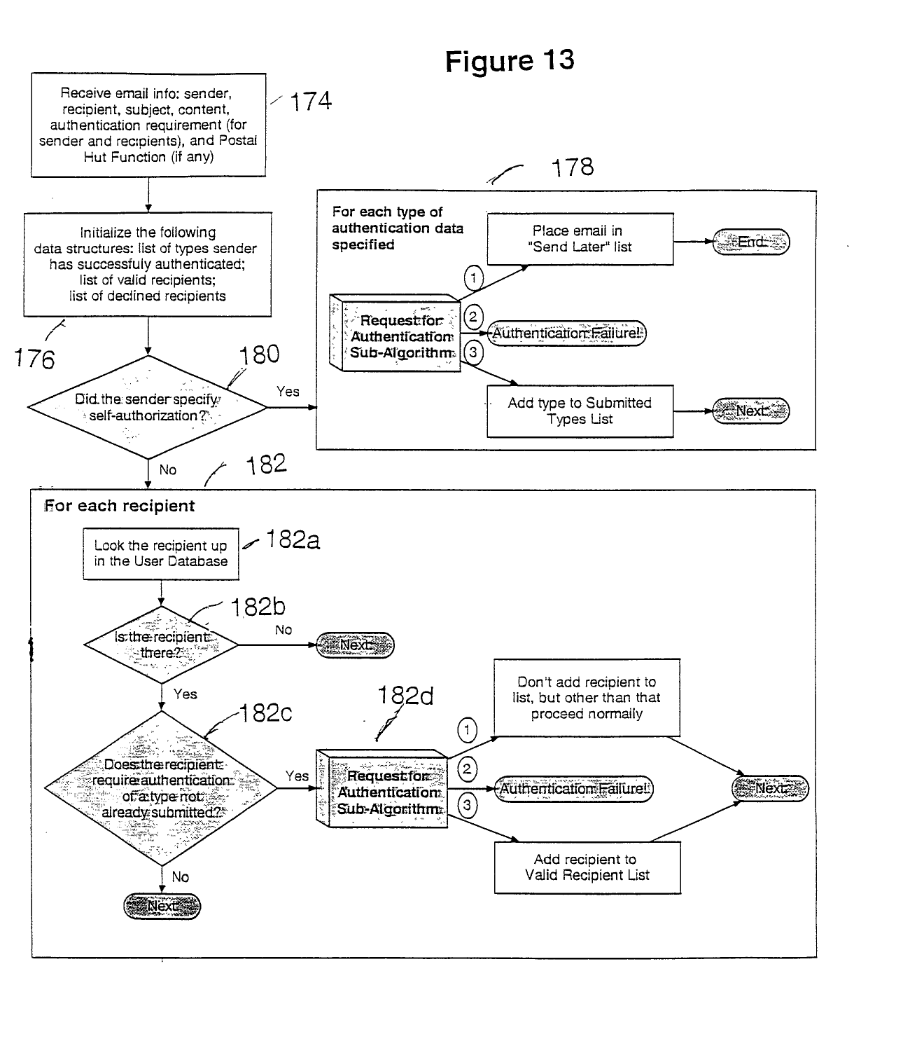

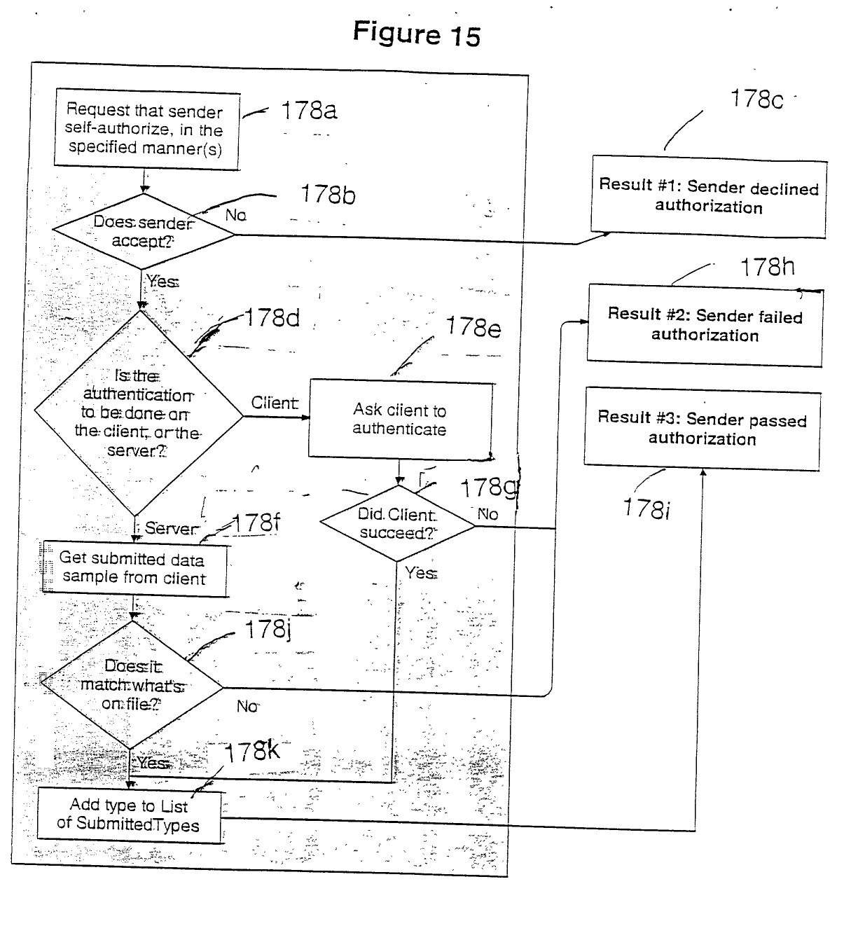

Referring to FIG. 13, mail center or e-mail center 30 is illustrated. In block 174, e-mail center 30 receives the content and gives the content or e-mail a unique ID. Then, in block 176, the data structures are initialized. Next, in block 180, e-mail center 30 checks if sending computer 12 specifies self-authorization. If computer 12 specifies self-authorization, then block 178 is utilized which is described in FIG. 15. If computer 12 does not specify self-authorization, then block 182 is utilized. In block 182, block 182a checks whether the recipient or receiving computer 22 is found in e-mail center 30 database, then sending computer 12 may input the recipient's information. In block 182b, the recipient's information is checked to see whether it is at the mail center. Then, in block 182c it is checked whether the recipient requires authentication. If the recipient or receiving computer 22 requires authentication then an authentication algorithm is utilized in block 182d, which is similar to block 178 described in FIG. 15. If receiving computer 22 does not required authentication, the e-mail center proceeds to the next step.

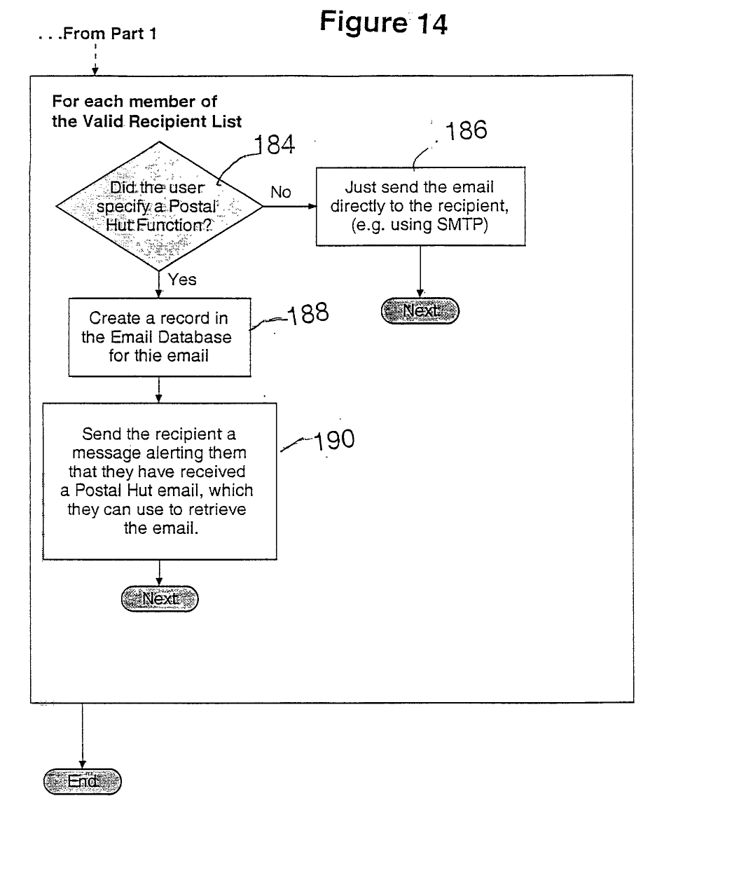

Referring to FIG. 14, there is a continuation of the process for operating e-mail center 30. If there is no need for authentication, then, in block 184, e-mail center 30 asks if a Postal Hut function was selected. If there was no Postal Hut function selected, as in block 186, then the email is sent directly to the recipient or receiving computer 22 by utilizing an SMTP server or any other means that may be used to electronically transfer a message. If the user did specify a Postal Hut function, then, in block 188, e-mail center 30 creates a record of the content in data storage system 36 using the ID as a key and storing the sender, recipient, content, a time-stamp, the requested Postal Hut function, etc. Those of ordinary skill in the art realize that a data storage system can be an independent device or it can be part of e-mail center 30. Then, in block 190, e-mail center 30 sends recipient or computer 22 a Uniform Resource Locator (URL) alerting it that there is a message.

Referring to FIG. 15, there is an illustration of the authentication process utilized by email center 30. In block 178a, sending computer 12 (sender) is asked to self-authorize or authenticate itself. In block 178b, the sender is given a choice to accept the self-authorization. If sending computer 12, in block 178c, chooses not to accept the self-authorization, then the self-authorization is declined in block 178c. If sending computer 12 does accept, as in block 178d, then sending computer 12 must decide where the authorization should be done on the client or server end. If sending computer 12 decides to authorize at the client end, as in block 178e, the client is checked in block 178g to ascertain if it has been self-authorized. If the self-authorization is not successful, as in block 178h, then sending computer 12 failed authorization. If the self-authorization is successful, then in block 178k there is an addition of types to list of submitted types which illustrate in block 178i sending computer 12 has passed authorization. If the authentication is done at the server end, then, as in block 178f, the server obtains the submitted data from a client. In block 178j, the submitted data is compared to the data on file. If the data doesn't match then, as in block 178h, sending computer 12 fails authorization. If the data does match, then, as in block 178k, there is addition of types to list of submitted types which illustrate in block 178i sending computer 12 has passed authorization.

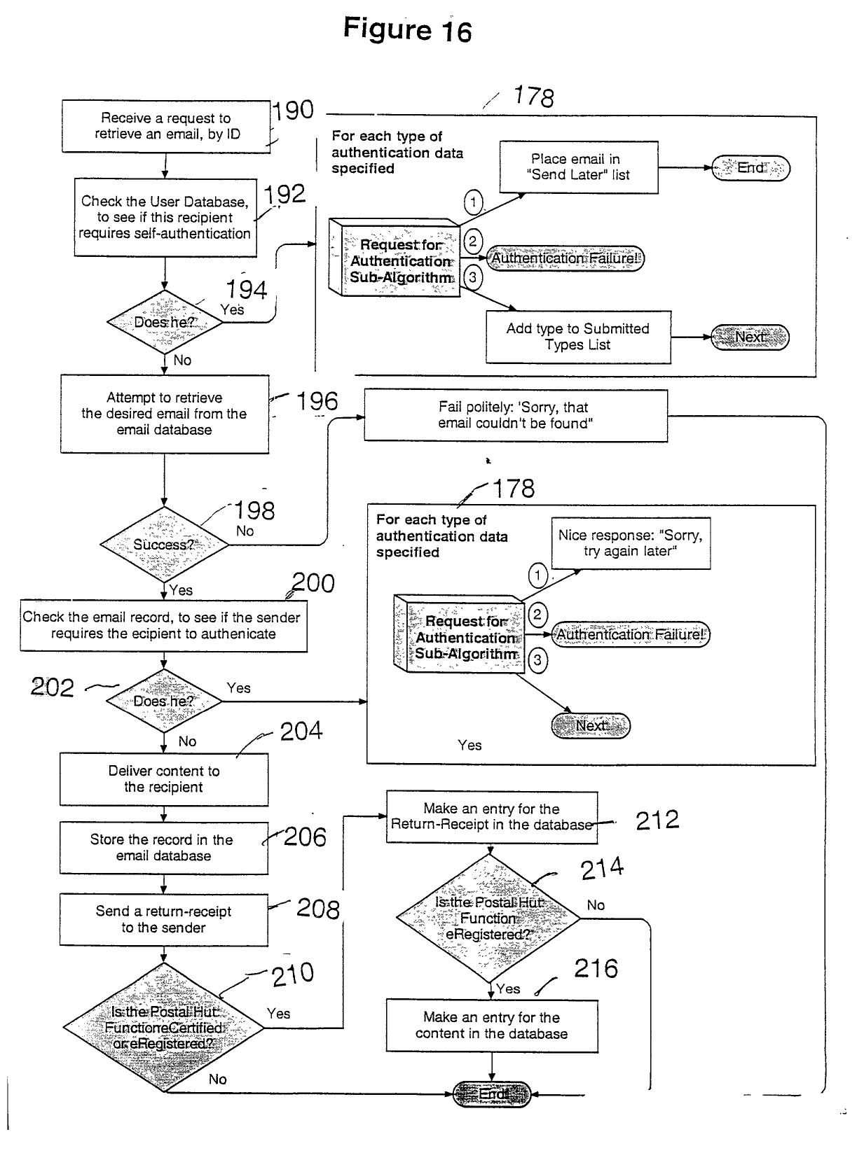

Referring to FIG. 16, there is an illustration of an e-mail retrieval request at a mail center or e-mail center 30. In order to retrieve the e-mail, the URL points computer 22 to a Postal Hut Website where the message is located on e-mail center 30. In block 190, e-mail center 30 receives a request to retrieve an email by ID from a recipient or receiving computer. Then, in block 192, the database on e-mail center 30 checks to see if receiving computer 12 utilizes a database that requires self-authentication. In block 194, e-mail center 30 checks if authentication is required. If authentication is required then e-mail center 30 goes through the same process illustrated in FIG. 15. If authentication is not required, then block 196 attempts to retrieve the e-mail from the e-mail database on e-mail center 30. Then, in block 198 there is a check to see if the retrieval has been successful. If the retrieval is not successful, then computer 22 receives a message that the email cannot be found. If the retrieval process is successful, as in block 200, then the email record in block 202 is checked to see if the sender requires the recipient to authenticate. If the sender receives authentication, then the authentication process of FIG. 15 is utilized. If receiving computer 12 is not required to authenticate, as in block 204, then the content of the e-mail is delivered to the computer 22. Then, in block 206 the e-mail is stored as a record in the e-mail database. Next, in block 208, a return-receipt is sent to sending computer 12. Next, in block 210, Postal Hut function is checked to see if it is eCertified or eRegistered. If the Postal Hut function is eCertified or eRegistered, as in block 212, then an entry for return-receipt is put into the e-mail center database. Next, in block 214, there is a check to see if the Postal Hut function is eRegistered. If the Postal Hut function is not eRegistered, then the email program will end. If the Postal Hut function is eRegistered, then, as in block 216, an entry for the e-mail content is inputted into e-mail center 30 database.

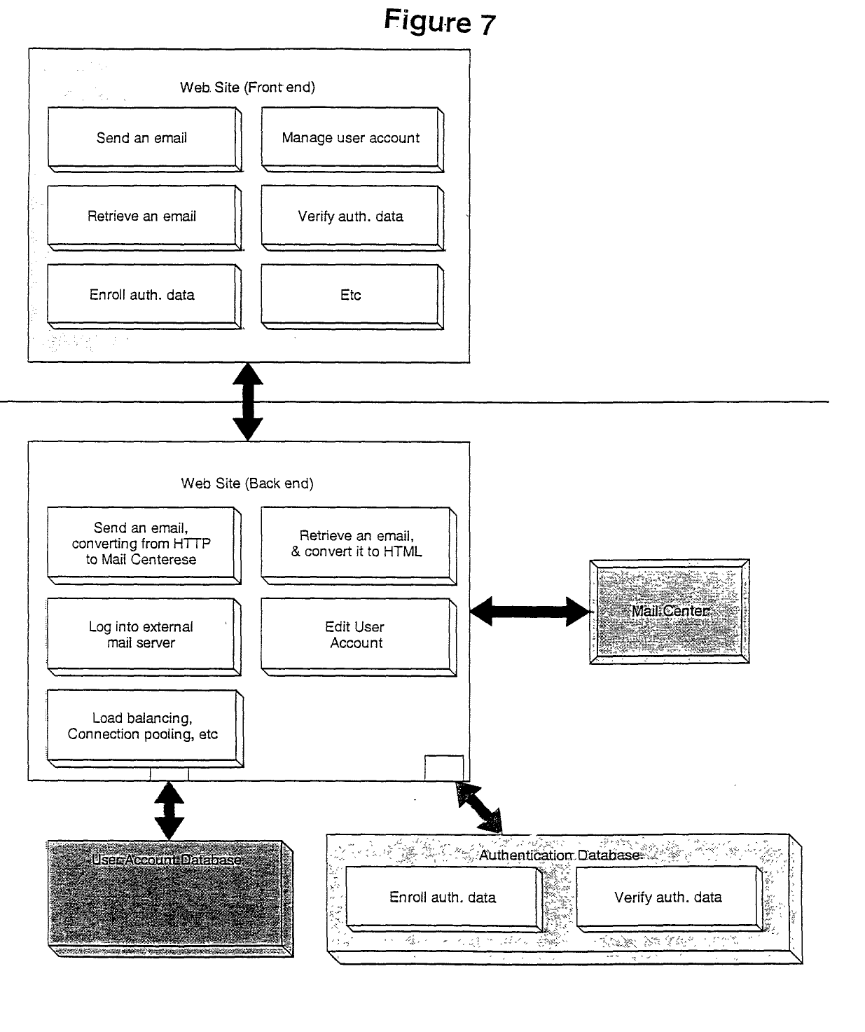

Referring to FIG. 7, computer 22 may receive the e-mail by going through an authentication database if the sender or recipient chooses to do so. The authentication database is one of the functions provided by e-mail center 30. An authentication database consists of a field for the username and one for each type of possible authentication data. When a user attempts to authenticate himself, he will use his username and submit authentication data, e.g. voice recognition, retinal scan, fingerprint, a password, etc. which will be verified against the enrolled authentication data in the user's authentication database record. If the user chooses not to use the authentication database on e-mail center 30, then the user can utilize an external authentication database. The authentication database provides a URL or other means of naming the desired database. When the user submits an authentication form, he will also submit the URL that will correlate with e-mail center 30. The authentication database at e-mail center 30 can be utilized by the sender or recipient to provide notification or proof that the e-mail message was received or not received by the correct party.

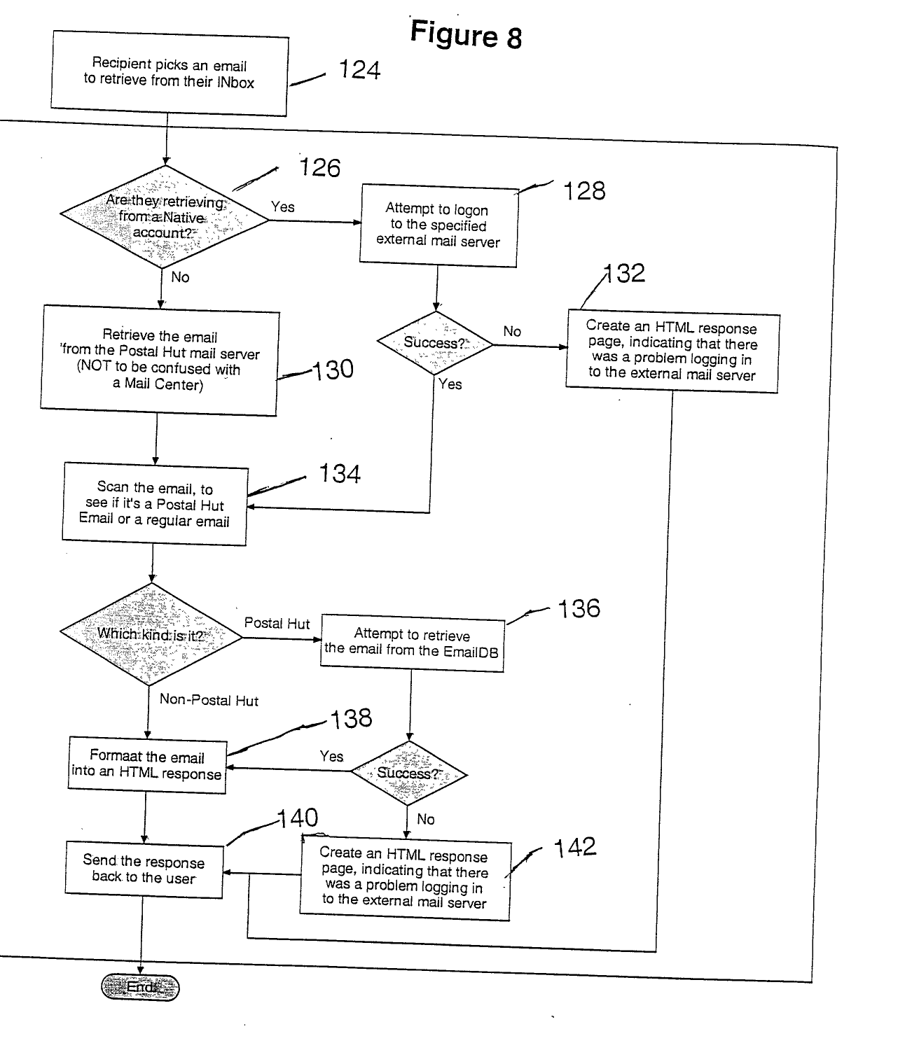

With regard to computer 22 receiving email from a Pure Web solution, there are four different ways in which the e-mail can be received, depending on what type of an account computer 22 utilizes and if the authentication is utilized. Referring to FIG. 8, the flowchart provides a description of retrieving e-mail if authentication is not utilized by sending computer 12. In block 124, the recipient chooses an inbox to receive e-mail. In this first case, the recipient has a Postal Hut account and receives non-Postal Hut e-mail. In block 126 if computer 22 is retrieving the e-mail from a Postal Hut account (Native Account). In block 128, computer 22 attempts to log onto a specified external mail server in block 128. If the receiving computer 22 cannot log on then block 132 creates a HTML response page stating there was a problem logging into the external mail server. If the attempt is successful, then block 134 checks if the e-mail is a Postal Hut e-mail or regular e-mail. In this case the e-mail is a non-Postal Hut e-mail so the e-mail is formatted into a HTML response in block 138. Next, in block 142 the response is sent back to receiving computer's 22 Web browser.

In this second instance, the receiving computer has an external account and receives non-Postal Hut e-mail. In this method receiving computer 22 does not utilize a Postal Hut account so block 130 is utilized to retrieve the e-mail from the Postal Hut Mail Server. Next, in block 134 the e-mail is scanned to check if it's a Postal Hut e-mail or regular e-mail. Since the e-mail is a non-Postal hut e-mail, then in block 138 the e-mail is formatted into a HTML response. In block 142, the HTML response is sent to sending computer 12 or receiving computer 22.

Third, if computer 22 utilizes a Postal Hut account and receives a Postal Hut e-mail, then, the computer 22 will receive a URL. In block 128, if computer 22 has a Postal Hut account then the account attempts to log onto an external mail server. If the attempt to log on is not successful, then block 132 creates a HTML response page stating there was a problem logging into the external mail server. If the attempt to log onto the e-mail server is successful, then the e-mail is scanned, in block 134, to check if it is a Postal Hut e-mail or a regular e-mail. Since this is a Postal Hut account with a Postal Hut e-mail, block 136 is utilized to attempt to retrieve the e-mail from the e-mail database. If block 136 is not able to retrieve the e-mail, then block 142 creates a HTML response page stating there was a problem logging into the external mail server. If block 136 is able to retrieve the e-mail, then block 138 is utilized to format the e-mail into a HTML response. Then, in block 142 the HTML response is sent to sending computer 12 or receiving computer 22. The HTML response or Uniform Resource Locator directs the computer 22 to the Postal Hut website where it can retrieve the e-mail message. If computer 22 goes to the website it can choose to view the newly received URL with the e-mail or it can review other e-mail at the website.

The last method for receiving an e-mail encompasses utilizing a non-Postal Hut account to receive a Postal Hut e-mail. In block 126, it is ascertained that receiving computer 22 is not utilizing block 130, the e-mail is retrieved from the Postal Hut mail server. Next, in block 134 there is a check if the e-mail is a Postal Hut e-mail or a regular e-mail. Since it is a Postal Hut e-mail, block 136 attempts to retrieve the e-mail from the e-mail database. If the attempt is not successful then block 142 creates a HTML response page stating there was a problem logging into the external mail server. If the attempt is successful, then, in block 138, the e-mail is formatted into a HTML response that is sent to block 142. In block 142, the e-mail is sent to receiving computer's 22 Web browser.

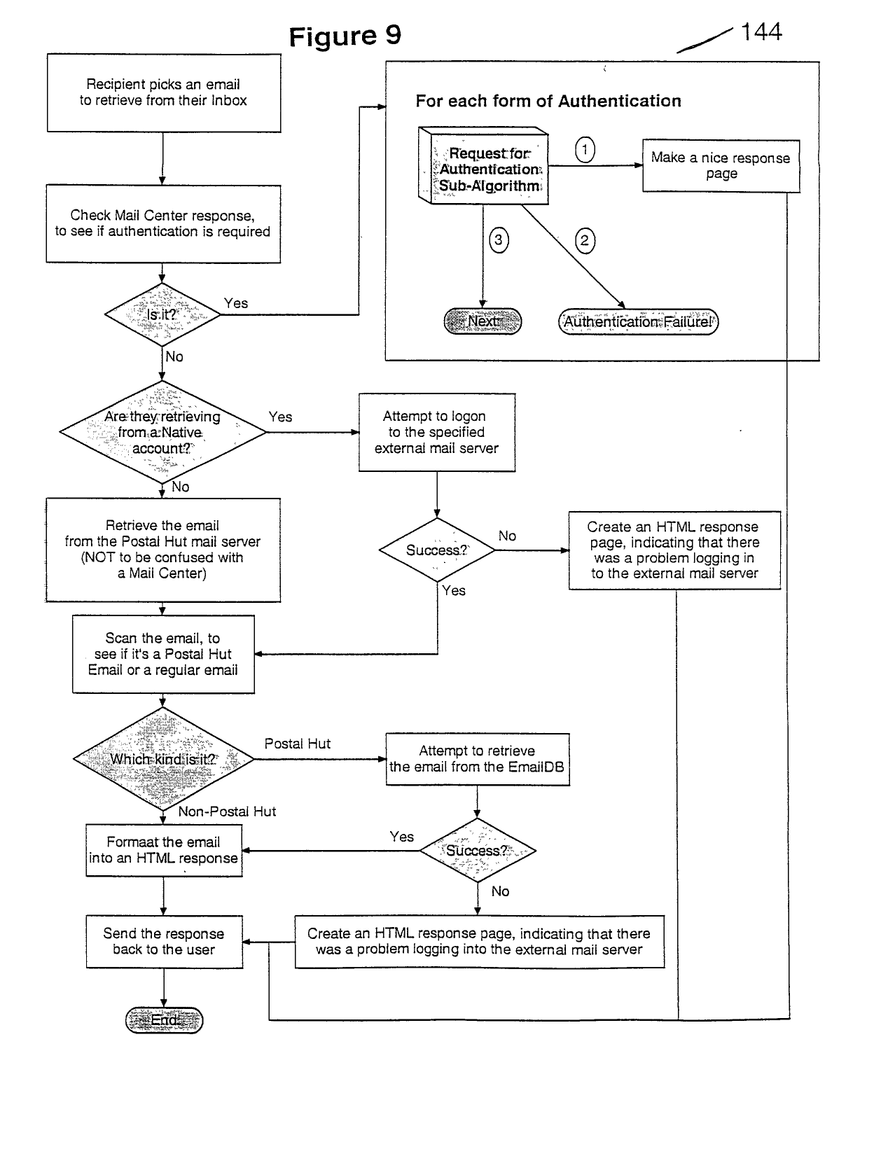

If sending computer 12 requests authentication in e-mail center 30, then the receiving computer may go through an authentication process. Referring to FIG. 9, the same flowchart as in FIG. 8 used to depict the retrieval process for email but FIG. 9 also illustrates the authentication process. In block 144, the authentication process is carried out by receiving computer 22 inputting information that will be compared within an authentication database located at e-mail center 30.

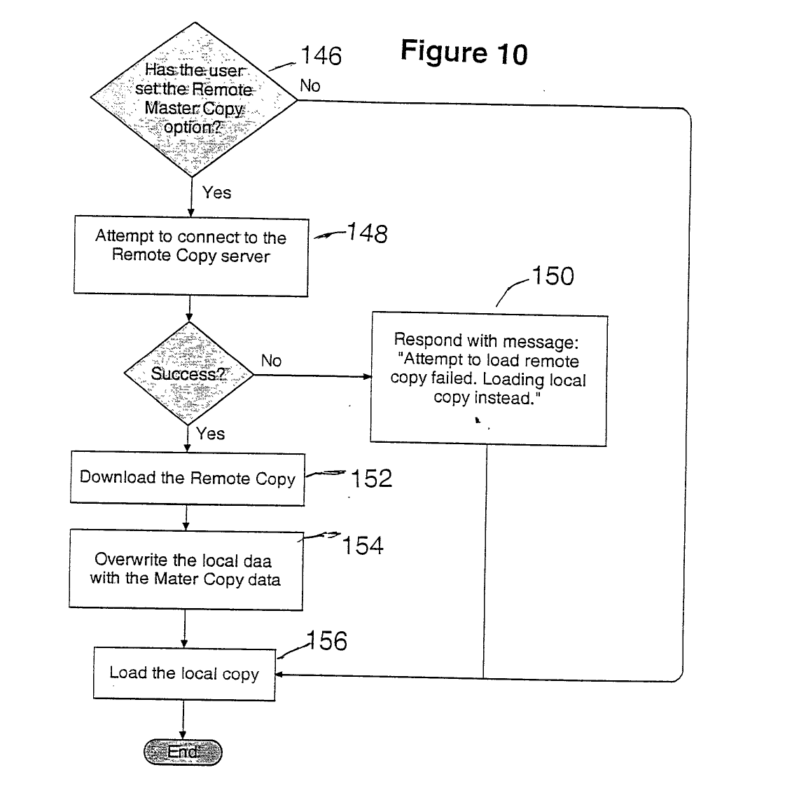

Another method for sending an e-mail message encompasses computer 12 utilizing a software program called a specially enhanced e-mail service or Postal Hut service. Referring to FIG. 10, there is a flowchart depicting how the specially enhanced e-mail service is utilized. When the specially enhanced e-mail service is utilized by computer 12, the sender may load data from a configuration database SMTP, from the sender, that contains information about the sender and the recipient. In block 146, Specially enhanced e-mail service checks if sending computer 12 has a remote Master copy or configuration database which includes information such as a username, a password, authentication etc. In block 156, if sending computer 12 has not provided a remote master copy, then sending computer 12 can load a local copy onto the specially enhanced e-mail service. In block 148, if sending computer 12 provided a remote master copy option there is an attempt to log onto the remote master copy option. In block 150, if the attempt is not successful, a message is sent to sending computer 12 stating that the attempt to load the remote copy failed and the local copy is being loaded. In block 152, if the attempt is successful, then the remote copy is downloaded onto sending computer 12. Next, in block 154 the local data is overwritten by the remote master copy data. Then, in block 156 the local copy is loaded onto sending computer 12.

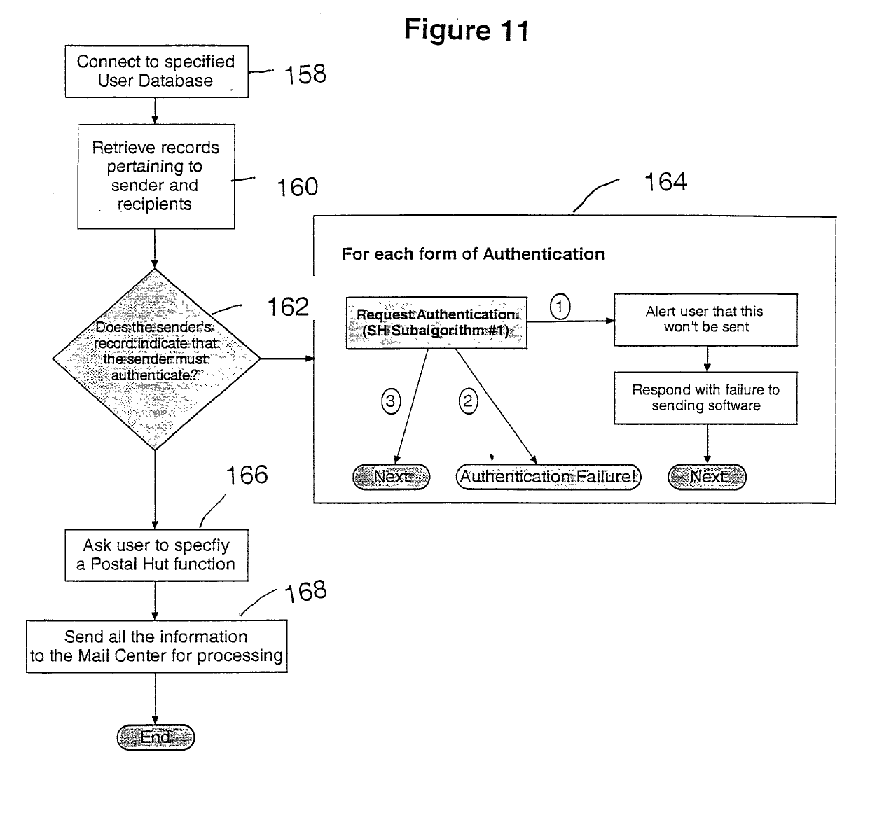

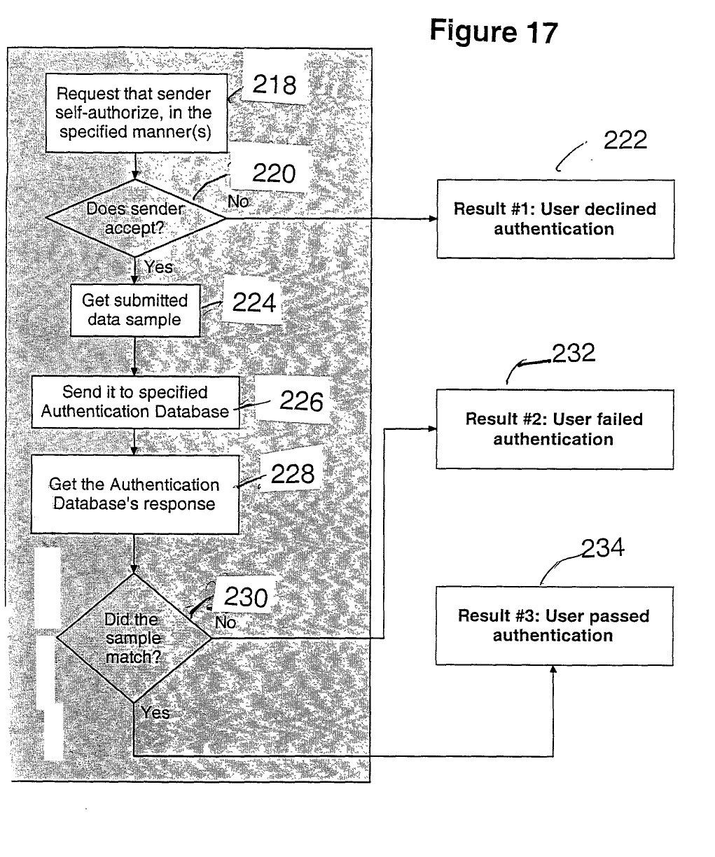

Referring to FIG. 11, a flowchart depicts the connection to a remote master copy or a local copy containing a database of information. In block 158, the connection between sending computer 12 and remote master copy or local copy is established. Next, in block 158 sending computer 12 utilizes the local copy to retrieve the records, at block 160, pertaining to configuration database SMTP, from the sender that contains information about the sender and the recipient. In block 162, sending computer 12 reviews the local copy to see if there needs to be authentication. If there is no authentication necessary, then sending computer 12, in block 166, has to specify a Postal Hut function, and in block 168 the local copy and Postal Hut function is sent to a mail center such as e-mail center 30. If authentication must occur, then block 164 is utilized to authenticate the information, which is illustrated in FIG. 17. If the authentication process is initialized and it does not allow sending computer 12 to receive authentication a failure alert is sent to sending computer 12. In block, 162 if sending computer 12 passes then authentication process, then in block 166 the sending computer is asked for Postal Hut functions. After the sending computer 12 selects Postal Hut functions, then, in block 168, the local copy and Postal Hut functions are sent to a mail center such as e-mail center 30.

Referring to FIG. 17, there is an illustration of an authentication sub-algorithm for the specially enhanced email service. In block 218, there is a request that sending computer 12 self-authorizes itself by voice recognition, retinal scan, password, etc. In block 220, computer 12 is checked to see if it accepts the self-authorization. If computer 12 does not accept self-authorization, then, as in block 222, computer 22 declines authentication. If computer 12 does accept self-authorization, as in block 224, then computer 22 gives the specially enhanced e-mail service a data sample. Next, in block 226, the data sample is sent to an authentication database. Then, in block 228, the specially enhanced email service obtains the authentication database response. Next, block 230 checks if the sample is a match with a sample in the authentication database. If, as in block 232, there is no match between the sample and the sample in the authentication database, then sending computer 12 fails authentication. If, as in block 234, the sample is a match with the sample in the authentication database, then the user passed authentication.

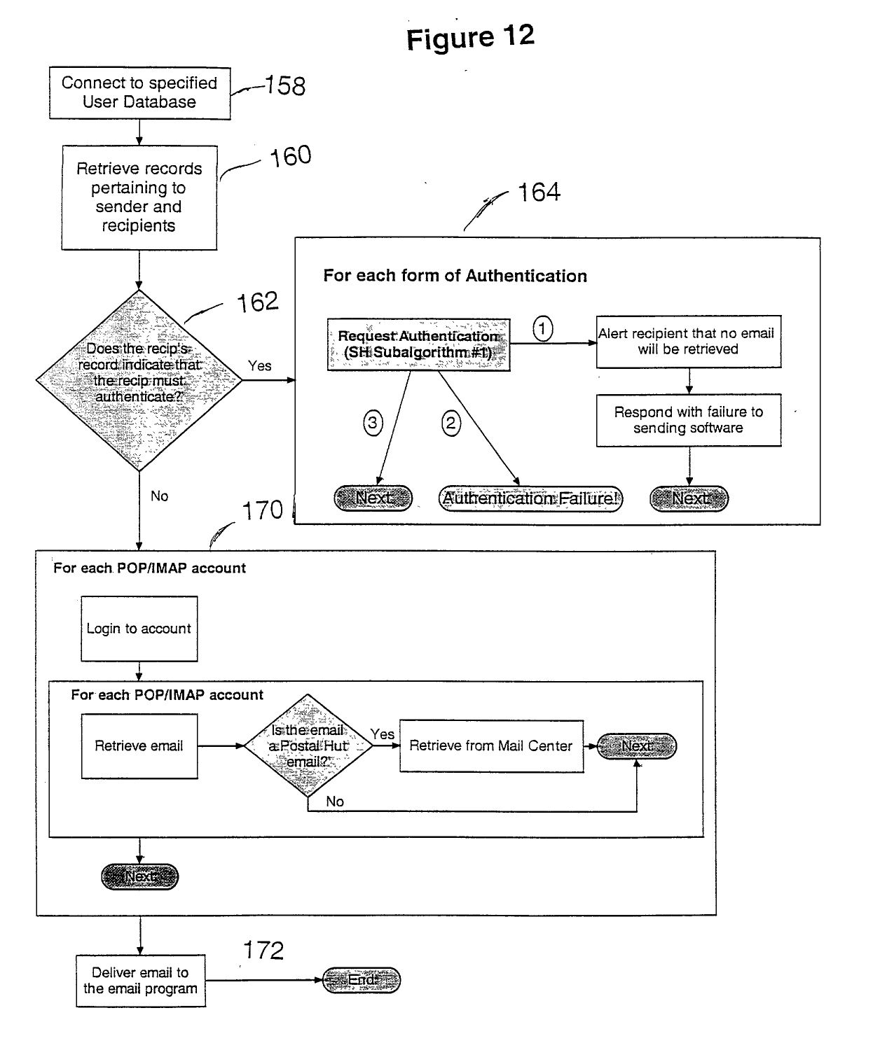

Referring to FIG. 12, there is a similar flowchart to FIG. 11 except there is a block 170 depiction of a POP/IMAP account that allows computer 12 retrieve e-mail. In this FIG. 12, after block 162, where the sender does not have to authenticate the email sent to block 170. In block 170, sending computer 12 has to login to a POP/IMAP account. Next, the e-mail is checked to see if it a Postal Hut e-mail. If the e-mail is a Postal Hut e-mail, then the e-mail is retrieved from the mail center or e-mail center 30 and the e-mail is sent to the e-mail program in block 172. If the e-mail is not a Postal Hut e-mail, then the e-mail cannot be retrieved.

After the e-mail message is processed by e-mail center 30, it is sent to a recipient's computer 22. Next, if receiving computer 22 also utilizes a Postal Hut service it can operate in the same manner as computer 12's Postal Hut service in utilizing the authentication database. When computer 22 is authenticated by the Postal Hut service, then computer 22 can retrieve the e-mail through the Postal Hut service.

As noted previously, the present invention has been described in general terms, it being understood that the specific details or sequences of operations are not critical for the practicing of the invention. It will be evident to those skilled in the art as to what changes would need to be made in order to modify the described system hardware and/or software to achieve the same or other objectives of the invention.

While the invention has been illustrated and described as making use of an e-mail center that provides various functions/services, the invention can also be implemented without an e-mail center. Many of the features can be achieved between terminals 12, 24, and the algorithms and flow charts do not significantly change. In that event, it may be possible to download the software or algorithms from any server. Alternatively, the software can be stored on any medium, such as a CD-ROM and purchased off the shelf. Regardless of how the software is ultimately loaded on the computer terminals, once it is in place, it can be used to certify, authenticate, etc., with or without biometrics. Also, while the present invention has been shown and described as being used between two individual locations or terminals, it will clear to those skilled in the art that it is also possible for a single individual or entity to send an e-mail intended to be received by any member of a predetermined class of recipients. Thus, if health records are transmitted to a hospital or other health care center, the sender can specify who can and cannot have access to that document or file. In such a case, the identifications of the individuals and the class can be stored and suitable biometric or other means can be used to identify and authenticate each member of the class. This would prevent unauthorized entities from outside the class from obtaining access to sensitive information. This would be useful in implementing the HIPAA security rules by health plans, health care clearinghouses and health care providers, who are the covered entities under the regulations.

While this invention has been described in detail with particular reference to preferred embodiments thereof, it will be understood that variations and modifications will be effected within the spirit and scope of the invention as described herein and as defined in the appended claims.

What we claim is:

1. A method of providing specialized e-mail services to a sender, recipient or both, over a communications network, said method comprising:
establishing an on-line session with a computer at an e-mail center;
sending an e-mail packet including an e-mail message to a recipient together with a request for a specified verification e-mail service to the e-mail center;
transmitting the e-mail to an e-mail address accessible by a computer operated by a recipient,
receiving notification when said recipient at least receives said e-mail; and
providing, by e-mail center, at least requested e-mail notification to said sender.

2. The method as defined in claim 1, wherein said communication network comprises the Internet.

3. The method as defined in claim 1, wherein the user establishes a secure session with computer at e-mail center.

4. The method as defined in claim 1, wherein said session between the user and the e-mail center requires specified software, and further comprising the step of loading specified software on the computer operated by sender.

5. The method as defined in claim 1, wherein said specialized e-mail services include at least one specialized service selected from the group consisting of:
notification that e-mail was sent,
notification that e-mail was received,
notification that e-mail was opened,
notification that e-mail was opened by intended recipient,
notification of time and/or date of receipt and/or opening of e-mail,
storage for future access of any selected notification information,
storage of e-mail message contents for future access,
verification of identity of sender,
verification of identity of recipient.

6. The method as defined in claim 5, further comprising transmitting by e-mail center requested specialized e-mail service to e-mail sender.

7. The method as defined in claim 5, further comprising transmitting by e-mail center requested specialized e-mail service to e-mail recipient.

8. The method as defined in claim 1, further comprising verifying the identity of sender and sending verification to e-mail center.

9. The method as defined in claim 8, further comprising sending verification of identity of sender to recipient with transmitted e-mail.

10. The method as defined in claim 9, wherein sender's identification verification is transmitted by the e-mail center to recipient pursuant to recipient's request.

11. The method as defined in claim 8, wherein verification is performed by use of biometric device associated with e-mail sender's computer.

12. The method as defined in claim 11, wherein sender's identity verification is obtained by checking sender's fingerprints.

13. The method as defined in claim 11, wherein sender's identity verification is obtained by checking sender's voice.

14. The method as defined in claim 11, wherein sender's identity verification is obtained by checking sender's anatomical features.

15. The method as defined in claim 1, further comprising the step of verifying the identity of recipient and sending verification to e-mail center.

16. The method as defined in claim 15, further comprising sending verification of identity of recipient to sender with transmitted e-mail.

17. The method as defined in claim 16, wherein recipient's identification verification is transmitted by the e-mail center to sender pursuant to sender's request.

18. The method as defined in claim 15, wherein verification is performed by use of biometric device associated with e-mail recipient's computer.

19. The method as defined in claim 18, wherein recipient's identity verification is obtained by checking recipient's fingerprints.

20. The method as defined in claim 18, wherein recipient's identity verification is obtained by checking recipient's voice.

21. The method as defined in claim 18, wherein recipient's identity verification is obtained by checking recipient's anatomical features.

22. The method as defined in claim 1, further comprising establishing by e-mail center whether recipient has capability of establishing special e-mail service requested by sender; and prompting recipient to download necessary application software to provide requisite capability prior to sending sender's e-mail.

23. The method as defined in claim 1, further comprising establishing by e-mail center whether recipient has capability of establishing verification of recipient's identity when such verification is requested by sender; and prompting recipient to establish such capability prior to sending sender's e-mail.

24. The method as defined in claim 5, wherein sender only requests selected notification and/or verification, and notification and/or verification is provided to sender without storage of such notification and/or verification.

25. The method as defined in claim 5, wherein sender requests selected notification and/or verification, and further comprising the steps of providing requested notification and/or verification to sender and storing such requested notification and/or verification for future use and/or reference.

26. The method as defined in claim 25, wherein sender specifies the period of time for which the requested notification and/or verification is to be stored.

27. The method as defined in claim 5, wherein sender requests contents of e-mail message to be stored, and further comprising the step of storing contents of e-mail message for further use and/or reference.

28. The method as defined in claim 27, wherein sender specifies the period of time for which the requested notification and/or verification is to be stored. (Compare claim 26.)

29. The method as defined in claim 28, wherein recipient requests verification of identity of sender prior to opening of e-mail; and further comprising sending to recipient by e-mail center verification of identity of sender subsequent to transmission of e-mail to recipient.

30. A method as defined in claim 1, wherein said e-mail packet is sent to a plurality of recipients in a predetermined class, any one of which can have access to the packet, and providing notification to the sender of the receipt of the packet by any intended recipient in the class.

31. A method as defined in claim 1, wherein said e-mail packet is sent to a single electronic address intended to be accessed by any one of a plurality of recipients in a predetermined class, and providing access only to entities with the class upon verification that the entity is a member of the class.

32. A method as defined in claim 31, wherein biometric verification is used to verify membership in the class.

33. An apparatus for providing specialized e-mail services to a sender, recipient or both, over a communications network, said apparatus comprising:
means for establishing an on-line session with a computer at an e-mail center;
means for sending by sender an e-mail packet including an e-mail message destined to a recipient together with a request for a specified verification e-mail service to the e-mail center;
means for transmitting from said e-mail computer the e-mail to an e-mail address accessible by a computer operated by a recipient,
means for receiving notification from said e-mail center when said recipient at least receives said e-mail; and
means for providing, by e-mail center, at least requested e-mail notification to said sender.

34. A method of transmitting information which contains a request for specified services on an e-mail system comprising:
connecting a sending computer to a communication network;
submitting said information from said sending computer to said communication network;
inputting said information onto a website server;
transmitting, by said website server, said information to a mail center;
receiving said information at said mail center;
creating a record of said information at said mail center;
storing said information by said mail center; and
sending an alert message to a receiving computer indicating that said information has been received.

35. The method of claim 34, further comprising inputting said information into a software program on said website server that interprets said information.

36. The method of claim 34, further comprising storing said record on a data storage system.

37. The method of claim 34, further comprising utilizing a Uniform Resource Locator in said alert message to point said receiving computer to said mail center to access said information.

38. The method of claim 37, further comprising retrieving said information by utilizing said Uniform Resource Locator.

39. The method of claim 34 wherein said information includes an authentication database.

40. The method of claim 39 further comprising confirming by said mail center that receiving computer has received said information.

41. A method for transmitting information that contains a request for specified services from an e-mail service comprising:
composing information on a sending computer;
sending said information, which includes an authentication database, to a software program on said sending computer;
comparing said authentication database with a database on said sending computer;
sending said information from said sending computer to a mail center;
processing said information at said mail center; and
sending said information from said mail center to a receiving computer.

42. The method of claim 41, further comprising authenticating said receiving computer.

43. The method of claim 41, further comprising retrieving said message from said software program.

44. The method of claim 41, further comprising utilizing said mail center to authenticate said receiving computer.

45. The method of claim 43 further comprising confirming by said mail center that receiving computer has received said information.
